(19) United States
(12) Patent Application Publication
(10) Pub. No.: US 2026/0352868 A1
(43) Pub. Date: Nov. 5, 2026

(54) VIDEO ENCODING AND DECODING

(71) Applicant: Tencent Technology (Shenzhen) Company Limited, Shenzhen (CN)

(72) Inventors: Renjie CHANG, Shenzhen (CN); Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/740,030

(22) Filed: Jul. 13, 2026

Related U.S. Application Data
(63) Continuation of application No. PCT/CN2025/089533, filed on Apr. 17, 2025.

(30) Foreign Application Priority Data
May 21, 2024 (CN) 202410650231.0

(51) Int. Cl. H04N 19/52; H04N 19/105; H04N 19/117; H04N 19/139; H04N 19/159; H04N 19/176

(52) U.S. Cl. CPC H04N 19/52; H04N 19/105; H04N 19/117; H04N 19/139; H04N 19/159; H04N 19/176

(57) ABSTRACT

Some aspects of the disclosure provide a method of video decoding. In some examples, a video bitstream including coded information of frames is decoded to obtain a candidate motion vector of a current block in a current frame, the current block is coded in an inter-frame template matching mode. A search area in a reference frame is searched based on the candidate motion vector to obtain location information of a matching block of the current block. Based on one or more first pixel values in a specified area in the reference frame, one or more second pixel values in an interpolation extension area for the matching block are determined. Interpolation filtering processing is performed based on the interpolation extension area to obtain pixel values of the matching block. Apparatus and non-transitory computer-readable storage medium counterpart embodiments are also contemplated.

### RELATED APPLICATIONS

The present application is a continuation of International Application No. PCT/CN2025/089533, filed on Apr. 17, 2025, which claims priority to Chinese Patent Application No. 202410650231.0, filed on May 21, 2024. The entire disclosures of the prior applications are hereby incorporated by reference.

### FIELD OF THE TECHNOLOGY

This application relates to the field of video encoding and decoding technologies, including video encoding and decoding methods and apparatuses, a computer-readable medium, and an electronic device.

### BACKGROUND

Inter-frame template matching (TM) is an important inter-frame prediction technology in the field of video coding, and aims to further refine a motion vector of a current block based on the template matching technology to obtain a more accurate prediction result of the current block. From the perspective of a decoder side, to generate a predicted block of the current block, when the inter-frame template matching technology is used, in addition to obtaining, based on the motion vector, a reference block having a pixel size corresponding to the current block in a reference frame, template matching may be further performed to search the reference frame for an area most similar to reconstructed pixels (templates) surrounding the current block, so as to improve motion estimation precision. In this process, an interpolation operation may further need to be performed, to improve template matching precision.

### SUMMARY

Embodiments of this disclosure include video encoding and decoding methods and apparatuses, a computer-readable medium, and an electronic device.

Some aspects of the disclosure provide a method of video decoding. In some examples, a video bitstream including coded information of frames is decoded to obtain a candidate motion vector of a current block in a current frame, the current block is coded in an inter-frame template matching mode. A search area in a reference frame is searched based on the candidate motion vector to obtain location information of a matching block of the current block. Based on one or more first pixel values in a specified area in the reference frame, one or more second pixel values in an interpolation extension area for the matching block are determined. Interpolation filtering processing is performed based on the interpolation extension area to obtain pixel values of the matching block.

Some aspects of the disclosure provide a method of video encoding. In some examples, a candidate motion vector of a current block to be encoded in an inter-frame template matching mode is determined. A search area in a reference frame is searched based on the candidate motion vector to obtain location information of a matching block of the current block. Based on one or more first pixel values in a specified area in the reference frame, one or more second pixel values in an interpolation extension area for the matching block are determined. Interpolation filtering processing is performed based on the interpolation extension area to obtain pixel values of the matching block. The current block is encoded into coded information in a video bitstream based on the pixel values of the matching block.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

An embodiment of this disclosure provides a video decoding method, including: decoding a video bitstream to obtain a candidate motion vector of a current block in an inter-frame template matching mode; searching a search area in a reference frame based on the candidate motion vector to obtain a matching block of the current block; determining, based on a pixel value in a specified area in the reference frame, a pixel value in an interpolation extension area configured for performing interpolation filtering processing on the matching block; and performing interpolation filtering processing on the matching block based on the interpolation extension area.

An embodiment of this disclosure provides a video encoding method, including: determining a candidate motion vector of a current block in an inter-frame template matching mode; searching a search area in a reference frame based on the candidate motion vector to obtain a matching block of the current block; determining, based on a pixel value in a specified area in the reference frame, a pixel value in an interpolation extension area configured for performing interpolation filtering processing on the matching block; and performing interpolation filtering processing on the matching block based on the interpolation extension area to perform encoding based on a result of interpolation filtering processing.

An embodiment of this disclosure provides a video decoding apparatus, including: a decoding unit, configured to decode a video bitstream to obtain a candidate motion vector of a current block in an inter-frame template matching mode; a search unit, configured to search a search area in a reference frame based on the candidate motion vector to obtain a matching block of the current block; a determining unit, configured to determine, based on a pixel value in a specified area in the reference frame, a pixel value in an interpolation extension area configured for performing interpolation filtering processing on the matching block; and a processing unit, configured to perform interpolation filtering processing on the matching block based on the interpolation extension area.

An embodiment of this disclosure provides a video encoding apparatus, including: a determining unit, configured to determine a candidate motion vector of a current block in an inter-frame template matching mode; a search unit, configured to search a search area in a reference frame based on the candidate motion vector to obtain a matching block of the current block; a determining unit, configured to determine, based on a pixel value in a specified area in the reference frame, a pixel value in an interpolation extension area configured for performing interpolation filtering processing on the matching block; and a processing unit, configured to perform interpolation filtering processing on the matching block based on the interpolation extension area.

An embodiment of this disclosure provides a computer-readable medium, having a computer program stored therein, the computer program, when executed by a processor (an example of processing circuitry), implementing the video decoding method or the video encoding method according to the foregoing embodiments.

An embodiment of this disclosure provides an electronic device, including: one or more processors; and a storage apparatus, configured to store one or more computer programs, the one or more computer programs, when executed by the one or more processors, causing the electronic device to implement the video decoding method or the video encoding method according to the foregoing embodiments.

An embodiment of this disclosure provides a computer program product, including a computer program, the computer program being stored in a computer-readable storage medium (for example, non-transitory computer-readable storage medium). A processor of the electronic device reads the computer program from the computer-readable storage medium and executes the computer program, to cause the electronic device to perform the video decoding method or the video encoding method according to the foregoing embodiments.

An embodiment of this disclosure provides a method for storing or transmitting a video bitstream, the video bitstream being decoded according to the foregoing video decoding method or being generated according to the foregoing video encoding method.

In technical solutions provided in some embodiments of this disclosure, after a video bitstream is decoded to obtain a candidate motion vector of a current block in an inter-frame template matching mode, a search area in a reference frame is searched based on the candidate motion vector to obtain a matching block of the current block; then, a pixel value in an interpolation extension area configured for performing interpolation filtering processing is determined based on a pixel value in a specified area in the reference frame; and interpolation filtering processing is performed on the matching block based on the interpolation extension area. It can be learned that, in the technical solutions in the embodiments of this disclosure, the pixel value in the interpolation extension area may be determined by using the pixel value in the specified area in the reference frame, so that during decoding, a decoder side does not need to read more reference pixel values from an off-chip memory. For example, the decoder side may determine the pixel value in the interpolation extension area by using pixel values in a reference block and the search area that have been read and buffered in an on-chip memory, and even does not need to wait for decoding the bitstream to obtain the pixel value in the interpolation extension area, thereby reducing bandwidth overheads in hardware implementation, and facilitating improving video encoding and decoding efficiency.

### BRIEF DESCRIPTION OF THE DRAWINGS

FIG. 1 is a schematic diagram of a system architecture to which a technical solution of an embodiment of this disclosure can be applied.

FIG. 2 is a schematic diagram of an arrangement mode of a video encoding apparatus and a video decoding apparatus in a streaming transmission system according to an embodiment of this disclosure.

FIG. 3 is a basic flowchart of a video encoder according to an embodiment of this disclosure.

FIG. 4 is a schematic diagram of an angular prediction direction in an intra-frame prediction mode according to an embodiment of this disclosure.

FIG. 5 is a schematic diagram of intra-frame prediction according to an embodiment of this disclosure.

FIG. 6 is a schematic diagram of an inter-frame prediction process according to an embodiment of this disclosure.

FIG. 7 is a schematic diagram of another inter-frame prediction process according to an embodiment of this disclosure.

FIG. 8 is a schematic diagram of pixel position distribution at sub-pixel precision according to an embodiment of this disclosure.

FIG. 9 is a schematic diagram of a template area according to an embodiment of this disclosure.

FIG. 10 is a diagram of shapes of a coarse search and a fine search according to an embodiment of this disclosure.

FIG. 11 is a schematic diagram of a search area and an interpolation extension area according to an embodiment of this disclosure.

FIG. 12 is a flowchart of a video decoding method according to an embodiment of this disclosure.

FIG. 13 is a schematic diagram of a search area according to an embodiment of this disclosure.

FIG. 14A and FIG. 14B are schematic diagrams of an interpolation extension area according to an embodiment of this disclosure.

FIG. 15 is a schematic diagram of setting a pixel value in an interpolation extension area according to an embodiment of this disclosure.

FIG. 16 is a schematic diagram of setting a pixel value in an interpolation extension area according to an embodiment of this disclosure.

FIG. 17 is a schematic diagram of setting a pixel value in an interpolation extension area according to an embodiment of this disclosure.

FIG. 18 is a schematic diagram of setting a pixel value in an interpolation extension area according to an embodiment of this disclosure.

FIG. 19 is a flowchart of a video encoding method according to an embodiment of this disclosure.

FIG. 20 is a block diagram of a video decoding apparatus according to an embodiment of this disclosure.

FIG. 21 is a block diagram of a video encoding apparatus according to an embodiment of this disclosure.

FIG. 22 is a schematic structural diagram of a computer system suitable for implementing an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

It is noted that the features, structures, or characteristics described in this disclosure may be combined in one or more embodiments in any suitable manner. In the following descriptions, there are many specific details for understanding the embodiments of this disclosure. However, when implementing the technical solutions of this disclosure, not all detailed features in the embodiments need to be used, one or more specific details may be omitted, or another method, element, apparatus, operation, or the like may be used.

Examples of terms involved in the aspects of the disclosure are briefly introduced. The descriptions of the terms are provided as examples only and are not intended to limit the scope of the disclosure.

In the embodiment of this disclosure, the term “module” or “unit” refers to a computer program with a preset function or a part of the computer program that works, together with other related parts, to achieve a predetermined objective, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including the module or unit function.

The block diagrams shown in the accompanying drawings are functional entities and do not necessarily correspond to physically independent entities. To be specific, the functional entities may be implemented in a software form, or the functional entities may be implemented in one or more hardware modules or integrated circuits, or the functional entities may be implemented in different networks and/or processor apparatuses and/or microcontroller apparatuses.

The flowcharts shown in the accompanying drawings are example descriptions, and do not necessarily include all content and operations/steps, nor do they have to be executed in the described order. For example, some operations/steps may be further broken down, but some operations/steps may be merged or partially merged. Therefore, an actual execution order may change according to an actual situation.

“A plurality of” mentioned in this disclosure means two or more. “And/or” describes an association relationship for describing associated objects and represents that three relationships may exist. For example, A and/or B may represent the following three cases: Only A exists, both A and B exist, and only B exists. The character “/” indicates an “or” relationship between the associated objects.

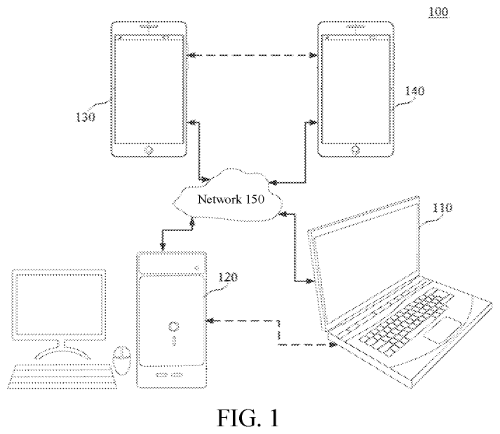

FIG. 1 is a schematic diagram of a system architecture to which a technical solution of an embodiment of this disclosure can be applied.

As shown in FIG. 1, the system architecture 100 includes a plurality of terminal apparatuses, and the terminal apparatuses may communicate with each other via, for example, a network 150. For example, the system architecture 100 may include a first terminal apparatus 110 and a second terminal apparatus 120 that are interconnected via the network 150. In the embodiment of FIG. 1, the first terminal apparatus 110 and the second terminal apparatus 120 perform unidirectional data transmission.

For example, the first terminal apparatus 110 may encode video data (for example, a video picture stream captured by the terminal apparatus 110) to transmit encoded video data to the second terminal apparatus 120 via the network 150, the encoded video data being transmitted in a form of one or more encoded video bitstreams, and the second terminal apparatus 120 may receive the encoded video data from the network 150, decode the encoded video data to recover the video data, and display a video picture based on the recovered video data.

In this embodiment of this disclosure, the system architecture 100 may include a third terminal apparatus 130 and a fourth terminal apparatus 140 that perform bidirectional transmission on encoded video data. For example, bidirectional transmission may be performed during a video conference. For bidirectional data transmission, one of the third terminal apparatus 130 and the fourth terminal apparatus 140 may encode video data (for example, a video picture stream captured by the terminal apparatus) to transmit encoded video data to the other one of the third terminal apparatus 130 and the fourth terminal apparatus 140 via the network 150. One of the third terminal apparatus 130 and the fourth terminal apparatus 140 may further receive the encoded video data transmitted by the other one of the third terminal apparatus 130 and the fourth terminal apparatus 140, decode the encoded video data to recover the video data, and display a video picture on an accessible display apparatus based on the recovered video data.

In the embodiment shown in FIG. 1, the first terminal apparatus 110, the second terminal apparatus 120, the third terminal apparatus 130, and the fourth terminal apparatus 140 may be servers or terminals, but the principle disclosed in this disclosure may not be limited thereto.

The server may be an independent physical server, or a server cluster or a distributed system including a plurality of physical servers; or may be a cloud server that provides basic cloud computing services such as a cloud service, a cloud database, cloud computing, a cloud function, cloud storage, a network service, cloud communication, a middleware service, a domain name service, a security service, a content delivery network (CDN), and big data and artificial intelligence platforms. The terminal may be a smartphone, a tablet computer, a notebook computer, a desktop computer, a smart speaker, a smart voice interaction device, a smart watch, a smart household appliance, a vehicle-mounted terminal, an aircraft, or the like, but is not limited thereto.

The network 150 shown in FIG. 1 represents any quantity of networks for transmitting encoded video data between the first terminal apparatus 110, the second terminal apparatus 120, the third terminal apparatus 130, and the fourth terminal apparatus 140, and includes, for example, a wired and/or wireless communication network. The communication network 150 may exchange data in a circuit-switched channel and/or a packet-switched channel. The network may include a telecommunication network, a local area network, a wide area network, and/or an internet. For the purpose of this disclosure, unless otherwise explained below, an architecture and a topology of the network 150 may be inconsequential to operations disclosed in this disclosure.

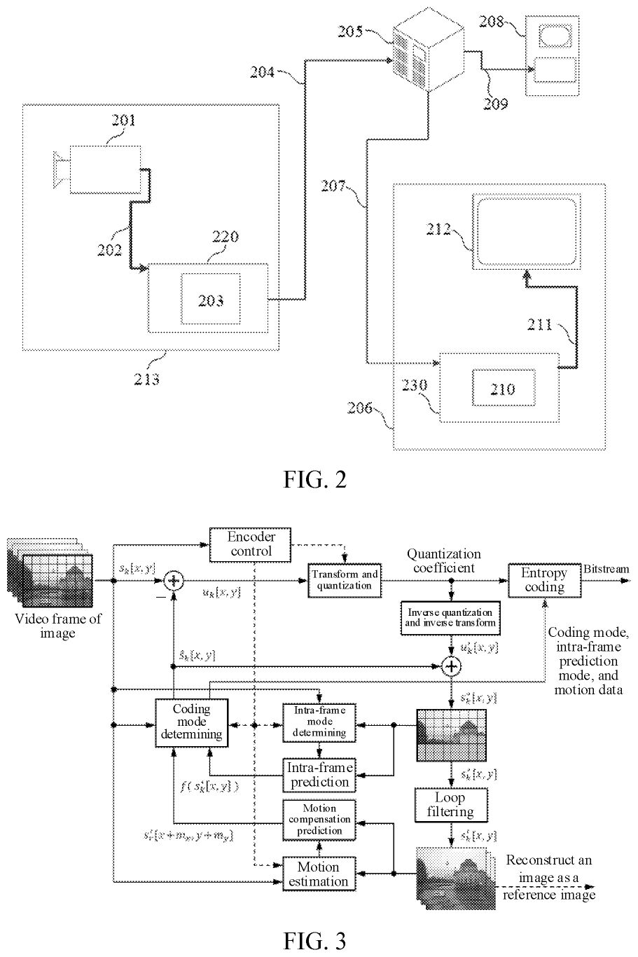

FIG. 2 shows an arrangement mode of a video encoding apparatus and a video decoding apparatus in a streaming transmission environment according to an embodiment of this disclosure. The subject matter disclosed in this disclosure may be equally applicable to other video-supporting applications, including, for example, a video conference, a digital television (TV), and an application that stores compressed videos in digital media such as a CD, a DVD, and a memory stick.

A streaming transmission system may include a collection subsystem 213. The collection subsystem 213 may include a video source 201 such as a digital camera. The video source creates an uncompressed video picture stream 202. In this embodiment, the video picture stream 202 includes a sample shot by the digital camera. Compared with encoded video data 204 (or an encoded video bitstream 204), the video picture stream 202 is drawn with a bold line to emphasize the video picture stream with a large data amount. The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware to implement or achieve aspects of the disclosed subject matter described in more detail below. Compared with the video picture stream 202, the encoded video data 204 (or the encoded video bitstream 204) is drawn with a fine line to emphasize the encoded video data 204 (or the encoded video bitstream 204) with a small data amount. The encoded video data may be stored in a streaming transmission server 205 for future use. One or more streaming transmission client subsystems, for example, a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes the incoming copy 207 of the encoded video data, and generates an outputted video picture stream 211 that can be presented on a display 212 (such as a display screen) or another display apparatus. In some streaming transmission systems, the encoded video data 204, video data 207, and video data 209 (for example, video bitstream) may be decoded in accordance with some video coding/compression standards.

The electronic apparatus 220 and the electronic apparatus 230 may include other components not shown in the figure. For example, the electronic apparatus 220 may include a video decoding apparatus, and the electronic apparatus 230 may further include a video encoding apparatus.

In some embodiments of this disclosure, high efficiency video coding (HEVC) and versatile video coding (VVC) in the international video coding standard and the China's national video coding standard AVS are used as an example. After a video frame of image is inputted, the video frame of image is partitioned into several non-overlapping processing units based on a block size, and a similar compression operation is performed on each processing unit. The processing unit is referred to as a coding tree unit (CTU) or a largest coding unit (LCU). The CTU may be further partitioned for finer granularity to obtain one or more basic coding units (CU). The CU is a most basic element in a coding section.

In some other embodiments, the processing unit may alternatively be a tile, which is a rectangular area in a multimedia data frame that can be independently decoded and encoded. In the first generation video coding standard stipulated by the alliance for open media video 1 (AV1), the tile may continue to be partitioned for finer granularity to obtain one or more largest coding blocks (for example, Superblock, SB for short). Then, the largest coding block is partitioned to obtain one or more blocks. Each block is a most basic element in one coding section. One SB may include several blocks.

The foregoing partition manner for the video frame of image may be referred to as a block partition structure. The following describes some concepts in a coding process.

Predictive coding: Predictive coding includes modes such as intra-frame prediction and inter-frame prediction. After an original video signal is predicted by using a selected reestablished video signal, a predicted video signal is obtained, and a residual video signal is further obtained. An encoder side selects a specific predictive coding mode for a current coding unit (or coding block), and notifies a decoder side of the predictive coding mode. Intra-frame prediction means that a signal configured for predicting the current coding unit is from an area in which coding and reconstruction have been performed and that is in the same image as the current coding unit. Inter-frame prediction means that a signal configured for predicting the current coding unit is from another encoded image (which is referred to as a reference image or a reference frame) different from a current image (a current frame) in which the current coding unit is located.

Transform and quantization: After a transform operation such as discrete Fourier transform (DFT) or discrete cosine transform (DCT) is performed on the residual video signal, the residual video signal is converted into a transform domain to obtain a transform domain signal, which is referred to as a transform coefficient. A lossy quantization operation is further performed on the transform coefficient, to discard specific information, so that a quantized signal is conducive to compression and expression. In some video coding standards, more than one transform mode may be selected. Therefore, the encoder side may select one of the transform modes for the current coding unit (or coding block), and notify the decoder side of the transform mode. Quantization fineness is usually determined by a quantization parameter (QP). A larger QP value indicates that coefficients in a larger value range are quantized into the same output, and therefore, larger distortion and a lower bit rate are usually caused. On the contrary, a smaller QP value indicates that coefficients in a smaller value range are quantized into the same output, and therefore, smaller distortion and a corresponding higher bit rate are usually caused.

Entropy coding or statistical coding: Statistical compression coding is performed on a quantized transform domain signal based on a frequency at which each value in the quantized transform domain signal appears, and finally, a binary (0 or 1) compressed bitstream is outputted. In addition, other information, for example, a selected coding mode or motion vector data, is generated through coding, and entropy coding also needs to be performed to reduce a bit rate. Statistical coding is a lossless coding mode, and can effectively reduce a bit rate required for expressing the same signal. A common statistical coding mode includes variable length coding (VLC) or content adaptive binary arithmetic coding (CABAC).

A content adaptive binary arithmetic coding (CABAC) process includes three operations: binarization, context modeling, and binary arithmetic coding. After binarization processing is performed on an inputted syntax element, binary data may be encoded by using a related coding mode and a bypass coding mode. In the bypass coding mode, a particular probability model does not need to be allocated to each bin, and an inputted bin value is directly encoded by using a simple bypass encoder, to accelerate an entire encoding and decoding process. In some aspects, different syntax elements are not completely independent of each other, and the same syntax element also exhibits a specific degree of memory. Therefore, according to a conditional entropy theory, conditional coding is performed by using another encoded syntax element, and coding performance can be further improved compared with independent coding or memoryless coding. Such encoded symbol information used as a condition is referred to as a context. In the related coding mode, bins of syntax elements are sequentially inputted into a context model. An encoder allocates an appropriate probability model to each inputted bin based on a value of a previously encoded syntax element or bin, and this process is context modeling. A context model corresponding to a syntax element may be positioned based on a context index increment (ctxIdxInc) and a context index start (ctxIdxStart). After a bin value and an allocated probability model are both inputted into a binary arithmetic encoder for encoding, a context model is updated based on the bin value, and this is an adaptation process during coding.

Loop filtering: Operations of inverse quantization, inverse transform, and prediction compensation are performed on a transformed and quantized signal to obtain a reconstructed image. Compared with an original image, due to quantization impact, a part of information of the reconstructed image is different from that of the original image. In other words, distortion occurs on the reconstructed image. Therefore, a filtering operation may be performed on the reconstructed image. A filter such as a deblocking filter (DB), a sample adaptive offset (SAO), or an adaptive loop filter (ALF) can effectively reduce a distortion degree generated during quantization. Because these filtered reconstructed images are used as references for subsequently encoded images to predict a future image signal, the foregoing filtering operation is also referred to as loop filtering, to be specific, a filtering operation inside a coding loop.

FIG. 3 is a basic flowchart of a video encoder according to an embodiment of this disclosure. In this process, intra-frame prediction is used as an example for description. A subtraction operation is performed on an original image signal sₖ[x,y] and a predicted image signal ŝₖ[x,y] to obtain a residual signal uₖ[x,y]. The residual signal uₖ[x,y] is transformed and quantized to obtain a quantization coefficient. Entropy encoding is performed on the quantization coefficient to obtain a encoded bitstream, and inverse quantization and inverse transform are performed on the quantization coefficient to obtain a reconstructed residual signal u′ₖ[x,y]. The predicted image signal sₖ[x,y] and the reconstructed residual signal u′ₖ[x,y] are superimposed to generate an image signal

$${s}_{k}^{*} [ x , y ] .$$

The image signal

$${s}_{k}^{*} [ x , y ]$$

is inputted into an intra-frame mode determining module and an intra-frame prediction module for intra-frame prediction processing, and a reconstructed image signal s′ₖ[x,y] is outputted through loop filtering. The reconstructed image signal s′ₖ[x,y] may be used as a reference image for a next frame, to perform motion estimation and motion compensation prediction. Then, based on a result s′ᵣ[x+mₓ,y+m_{y}] of motion compensation prediction and an intra-frame prediction result

$$f ( {s}_{k}^{*} [ x , y ] ) ,$$

the predicted image signal ŝₖ[x,y] in the next frame is obtained. In addition, the foregoing process continues to be repeated until encoding is completed.

Based on the foregoing encoding process, for each coding unit (or coding block), after obtaining a compressed bitstream (that is, a bitstream), a decoder side performs entropy decoding to obtain various types of pattern information and the quantization coefficient. Then, inverse quantization and inverse transform are performed on the quantization coefficient to obtain the residual signal. In addition, a predicted signal corresponding to the coding unit (or coding block) may be obtained based on known coding mode information. Then, the residual signal and the predicted signal are superimposed to obtain the reconstructed signal, and an operation like loop filtering is performed on the reconstructed signal to generate a final output signal. In this series of coding process, a coding framework makes decision based on rate-distortion optimization (RDO) to select an optimal coding parameter.

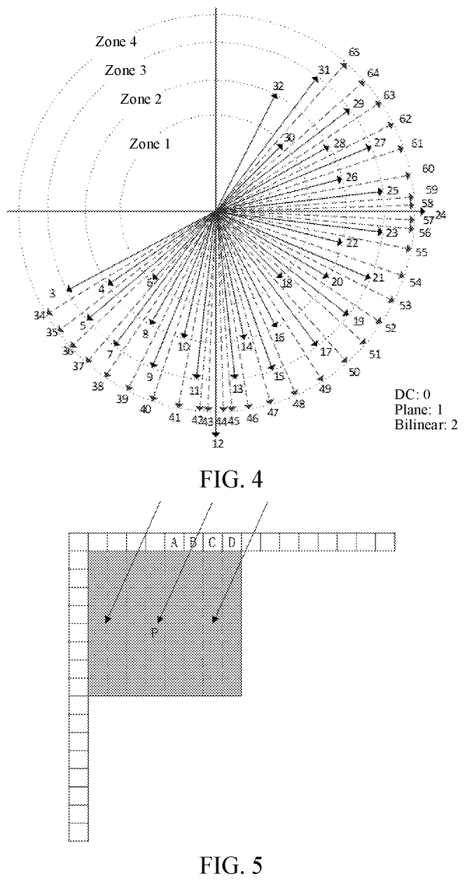

In the field of coding technologies, intra-frame prediction is a common predictive coding technology. For intra-frame prediction, a prediction value of a current coding block is derived from an adjacent encoded area of the current coding block based on correlation that exists between pixels in a video image in space domain. A second stage of the AVS3 adopts an extended intra prediction mode (EIPM). There are 33 intra-frame prediction modes in total in the AVS2, which is a previous generation of the AVS3, including 30 angular prediction modes and three special prediction modes (a plane prediction mode, a DC prediction mode, and a bilinear prediction mode). In the 33 intra-frame prediction modes, two most probable modes (MPM) are used, and modes other than the MPM use 5-bit fixed-length coding. To support finer angular prediction, the angular prediction modes are extended to 62 angle prediction modes in the AVS3. FIG. 4 is a schematic diagram of an angular prediction direction in an intra-frame prediction mode according to an embodiment of this disclosure. As shown in FIG. 4, numbers of newly added angular prediction modes are 34 to 65.

When an angular prediction mode is used, for a pixel (pixel position) in a current predicted block, a reference pixel value at a corresponding position in a reference pixel row or column is found based on an angle direction of the angular prediction mode, and is used as a prediction value of the pixel. FIG. 5 is a schematic diagram of intra-frame prediction according to an embodiment of this disclosure. As shown in FIG. 5, for a pixel P in a current predicted block, a position of a reference pixel is first determined, based on a prediction angle (as pointed by an arrow) in the figure, from an encoded pixel row located above the current predicted block, and then a value of the reference pixel at the position is used as a prediction value of the pixel P. Not all pixels in the current predicted block correspond to reference pixel positions at integer pixel precision based on the angle prediction mode. For example, a reference pixel position of the pixel P in FIG. 5 is a sub-pixel position between pixels B and C. Therefore, a prediction value of the pixel P needs to be obtained through interpolation by using surrounding pixels. To improve intra-frame prediction efficiency, an on-chip memory is usually used to store a reference pixel value for intra-frame prediction.

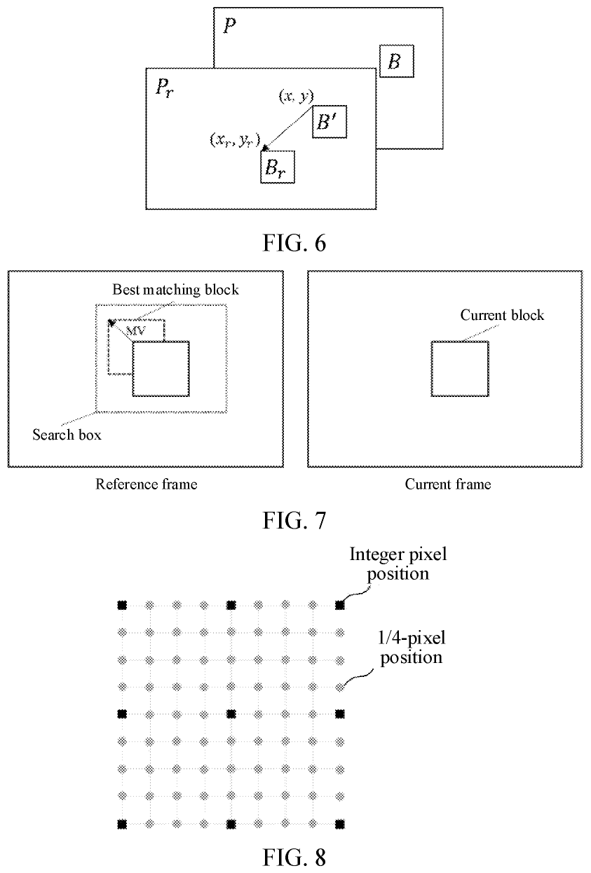

FIG. 6 is a schematic diagram of an inter-frame prediction process according to an embodiment of this disclosure. As shown in FIG. 6, inter-frame prediction uses correlation in video temporal domain, and uses a pixel in an adjacent encoded image (reference frame) to predict a pixel in a current image (current frame), to effectively remove video temporal domain redundancy, and effectively save bits for encoding residual data. P represents a current frame, Pr represents a reference frame, B represents a current coding block, and Br represents a reference block of B. Coordinates of B′ in the reference frame Pr are the same as coordinates of B in the current frame P. The coordinates of Br are (xᵣ,yᵣ), and the coordinates of B′ are (x, y). A displacement between the current coding block and the reference block of the current coding block is referred to as a motion vector (MV), where MV=(xᵣ−x, yᵣ−y). In other words, inter-frame prediction refers to a process of searching an adjacent encoded image (that is, a reference frame) based on a to-be-encoded current block in a current frame to obtain a reference block, so as to remove temporal domain redundancy of a video signal. As shown in FIG. 7, for the to-be-encoded current block in the current frame, a best matching block is obtained by searching a specific range (for example, a search area formed by a search box) in the reference frame according to a block matching criterion. The block matching criterion is a metric criterion between a current block and a matching block. Common block matching criteria in video coding may include matching criteria such as a minimum mean square error (MSE) and a sum of absolute difference (SAD). A motion vector is adjusted by using the matching criterion, and the search area in the reference frame is searched for a best matching block that has a SAD or minimum MSE with the current block to obtain a motion vector corresponding to the best matching block. A process of obtaining the motion vector is motion estimation.

During inter-frame prediction, a prediction value of a pixel in the current block may be obtained in the reference frame by using the motion vector (where this process is referred to as motion compensation). However, in an actual situation, motion of an object between adjacent image frames is not necessarily performed by using an integer pixel as a basic unit. Therefore, precision of motion estimation needs to be improved to a sub-pixel level, to be specific, interpolation needs to be performed on a reference image, to improve accuracy of motion compensation, thereby improving coding efficiency.

FIG. 8 is a schematic diagram of pixel position distribution at sub-pixel precision according to an embodiment of this disclosure. In FIG. 8, a black square represents an integer pixel position, and a gray circle represents a ¼-pixel position. A resolution formed by all integer pixels in one frame is equal to a video resolution. In the AVS3, a common inter-frame prediction mode supports five types of motion vector precision: ¼-pixel, ½-pixel, 1-pixel, 2-pixel, and 4-pixel. When MV precision is ¼-pixel or ½-pixel, an 8-tap interpolation filter may be used to perform interpolation to obtain a luma prediction value, and a 4-tap interpolation filter may be used to perform interpolation to obtain a chroma prediction value. When sub-pixels at a boundary of a current predicted block are interpolated, 8-tap or 4-tap interpolation calculation usually needs to be performed by additionally reading pixels outside the current predicted block. That is, a total quantity of pixels required in an interpolation process is usually greater than a total quantity of pixels in the current predicted block.

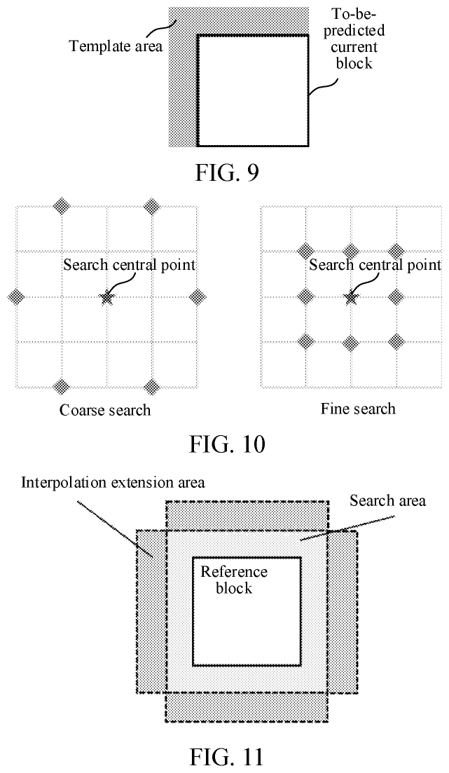

Inter-frame template matching is an important inter-frame prediction technology in the field of video coding, and aims to further refine a motion vector of a current block based on the template matching technology to obtain a more accurate prediction result. Inter-frame template matching is to find a motion vector, to minimize a matching error (cost) between a template of a current block and a template of a reference block. For example, M motion vector predictors (MVP) are first obtained from an advanced motion vector prediction (AMVP) mode, a skip mode, or a direct mode in an inter-frame prediction process, and are used as candidate MVPs of a to-be-predicted current block. Then, a template area is constructed based on reconstructed pixels surrounding the to-be-predicted current block. For example, the template area has a width of N pixels, and N is a positive integer. FIG. 9 is a schematic diagram of a template area according to an embodiment of this disclosure. As shown in FIG. 9, the template area is an L-shaped area that covers an upper side and a left side of the to-be-predicted current block and that has a width of N pixels. Then, a template matching search is performed on each available direction of a candidate MVP to determine a best matching block.

Usually, inter-frame template matching is performed by using a mode of a coarse search followed by a fine search. During the coarse search, in a reference frame corresponding to each candidate MVP, the candidate MVP is first used as a search start point (as an initial MVP), a search with a specific shape is performed to continuously update the initial MVP, and a cost between a template area in a reference frame corresponding to an updated MVP and a template area in the to-be-predicted current block is calculated during each search. If the template area in the reference frame is a sub-pixel precision area, in other words, needs to be generated through interpolation, the template area in the reference frame is generated by using modes such as bilinear interpolation and an interpolation filter, and then cost calculation is performed. During each search, a point having a lowest template cost is used as a central point for a next search. A current search ends if the central point is the best. Finally, after a best coarse search MV is obtained, the fine search is performed based on a specific shape to obtain a best MV. FIG. 10 shows examples of shapes of a coarse search and a fine search according to an embodiment of this disclosure. One of differences between the coarse search and the fine search lies in that search steps are different. After a best MV is obtained, during inter-frame template matching, the interpolation filtering method described in the foregoing embodiment may be used to generate a best matching block corresponding to a current block.

Therefore, to smoothly generate the best matching block of the current block, in addition to a reference block of the current block, inter-frame template matching may further need to obtain a pixel (for example, a pixel in a search area) in a specific range outside a reference block configured for template matching, and an additional pixel (a pixel in an interpolation extension area) that may be required in a final interpolation process. As shown in FIG. 11, in some embodiments, the search area is an area with a first specified size surrounding the reference block, and the interpolation extension area is an area with a second specified size outside the search area. The encoder side and the decoder side specify the same size for the search area and the same size for the interpolation extension area. The first specified size and the second specified size may be the same, or may be different. In some embodiments of this disclosure, the interpolation extension area is an area that is in the reference frame and that is extended based on the search area, and a pixel value in the interpolation extension area is configured for performing interpolation filtering processing on a matching block obtained through template matching.

From the perspective of the decoder side, to generate a predicted block of the current block, when a common inter-frame prediction technology is used, a reference block that is in the reference frame and that has the same pixel size as the current block and that is determined based on a motion vector may need to be read from an off-chip memory (or an off-chip buffer). When the inter-frame template matching technology is used, the pixel in the search area and the pixel in the interpolation extension area further need to be additionally read from the off-chip memory. It can be learned that the inter-frame template matching technology introduces large bandwidth overheads in hardware implementation, and excessively high hardware overheads limit actual application of the coding technology.

Based on this, embodiments of this disclosure include new video encoding and decoding technologies applied to inter-frame template matching, to determine a pixel value in an interpolation extension area by using a pixel value in a specified area in a reference frame, so that during decoding, a decoder side does not need to read more reference pixel values from an off-chip memory. For example, the decoder side may determine the pixel value in the interpolation extension area by using pixel values in a reference block and a search area that have been read and buffered in an on-chip memory, and even does not need to wait for decoding a bitstream to obtain the pixel value in the interpolation extension area, thereby reducing bandwidth overheads in hardware implementation, and facilitating improving video encoding and decoding efficiency.

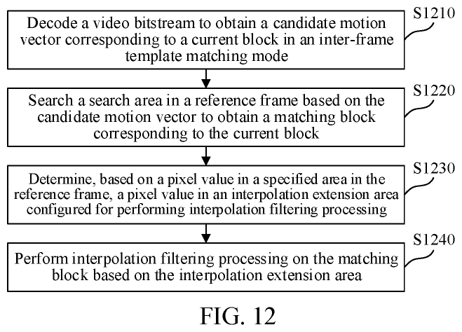

FIG. 12 is a flowchart of a video decoding method according to an embodiment of this disclosure. The video decoding method may be performed by a device having a computing processing function, for example, may be performed by a terminal device or a server. Referring to FIG. 12, the video decoding method includes at least S1210 to S1240, and details are described as follows.

S1210: Decode a video bitstream to obtain a candidate motion vector of a current block in an inter-frame template matching mode.

In some embodiments, a video includes a sequence of video image frames. The sequence of video image frames includes a series of images. Each image may be further partitioned into a slice. The slice may be further partitioned into a series of LCUs (or CTUs). The LCU includes several CUs. The video image frame is encoded in a unit of block. Some new video coding standards, for example, the H.264 standard, include a macroblock (MB). The macroblock may be further partitioned into a plurality of blocks that can be configured for predictive coding. In the HEVC standard, basic concepts such as a coding unit (CU), a prediction unit (PU), and a transform unit (TU) are used to partition a plurality of block units in terms of functions, and a new tree-based structure is used for description. For example, the CU may be partitioned into a smaller CU based on a quadtree, and the smaller CU may be further partitioned, to form a quadtree structure. The current block, a reference block, or a matching block in this embodiment of this disclosure may be a CU or a block smaller than the CU, for example, a smaller block obtained by partitioning the CU.

There may be one or more candidate motion vectors of the current block. The candidate motion vector of the current block may be obtained by decoding the video bitstream, or one or more motion vectors obtained from an AMVP mode, a skip mode, or a direct mode in an inter-frame prediction process may be used as the candidate motion vector of the current block.

S1220: Search a search area in a reference frame based on the candidate motion vector to obtain a matching block of the current block.

In some embodiments, the process of searching a search area to obtain a matching block of the current block may be: determining, in the reference frame, a reference block of the current block and a search start point in the search area based on the candidate motion vector; then, searching the search area based on the search start point for a best motion vector corresponding to the candidate motion vector; and determining the matching block of the current block based on the best motion vector. The process of searching the search area for a best motion vector corresponding to the candidate motion vector may be shown in the foregoing embodiment. A coarse search is followed by a fine search. After the best motion vector is obtained, the matching block of the current block may be determined based on the best motion vector.

In some embodiments, the search area is an area surrounding the reference block, and may include at least one of the following areas: a pixel area with a first quantity of rows located above the reference block; a pixel area with a second quantity of rows located below the reference block; a pixel area with a third quantity of columns located to the left of the reference block; a pixel area with a fourth quantity of columns located to the right of the reference block; a pixel area located to the upper left of the reference block; a pixel area located to the upper right of the reference block; a pixel area located to the lower left of the reference block; and a pixel area located to the lower right of the reference block. The first quantity, the second quantity, the third quantity, and the fourth quantity may be equal, or may not be equal, or may be partially equal. For example, the first quantity, the second quantity, the third quantity, and the fourth quantity may be selected from 1, 2, 3, 4, 5, and 6.

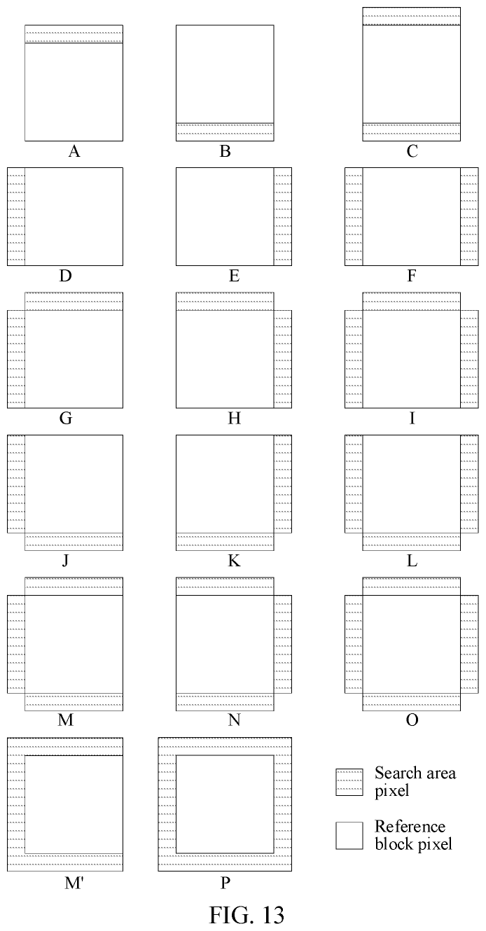

FIG. 13 is a schematic diagram of a search area according to an embodiment of this disclosure. As shown in FIG. 13, the search area may be arranged in a plurality of modes (where modes A to P in FIG. 13 are merely examples). The search area may further include pixel areas at an upper-left corner, an upper-right corner, a lower-left corner, and a lower-right corner in the modes A to O shown in FIG. 13. As shown in FIG. 13, the mode Mis used as an example. If the search area includes the pixel areas at the upper-left corner and the lower-left corner, the search area may be shown in the mode M′ in FIG. 13.

In some embodiments, a pixel value in the search area may be from a pixel in the reference frame, in other words, directly read from the reference frame, and no additional mode is needed for filling.

S1230: Determine, based on a pixel value in a specified area in the reference frame, a pixel value in an interpolation extension area configured for performing interpolation filtering processing on the matching block.

In some embodiments, a range of the interpolation extension area may be determined based on at least one of the following information: a position of the matching block, a quantity of taps of an interpolation filter, and a range of the search area.

In this embodiment of this disclosure, when the range of the interpolation extension area is determined, if a pixel required for performing interpolation filtering processing on the matching block is outside the range of the search area, the search area may be further extended to obtain the interpolation extension area. If a pixel required for performing interpolation filtering processing on the matching block is within the range of the search area, interpolation filtering processing can be implemented without extending the search area.

In some embodiments, extending the search area to obtain the interpolation extension area may be using a pixel area with a fifth quantity of rows located above the search area and a pixel area with a sixth quantity of rows located below the search area as the range of the interpolation extension area, if an absolute difference (to be specific, an absolute value of a difference) between horizontal coordinates of upper-left vertexes of the reference block and the matching block is less than or equal to a first threshold, and an absolute difference between vertical coordinates of the upper-left vertexes of the reference block and the matching block is greater than a second threshold. The fifth quantity and the sixth quantity may be equal, or may not be equal. For example, the fifth quantity and the sixth quantity may be selected from 1, 2, 3, 4, 5, and 6. The first threshold may be a difference between a half of a quantity of taps used by the interpolation filter in a horizontal direction and a specified constant. The second threshold may be a difference between a half of a quantity of taps used by the interpolation filter in a vertical direction and a specified constant. The specified constants may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the fifth quantity may be 1, and the sixth quantity may be 2; or if the quantity of taps is 6, the fifth quantity may be 2, and the sixth quantity may be 3; or if the quantity of taps is 8, the fifth quantity may be 3, and the sixth quantity may be 4; or if the quantity of taps is 12, the fifth quantity may be 5, and the sixth quantity may be 6.

In some embodiments, a pixel area with a fifth quantity of rows located above the search area is used as the range of the interpolation extension area, if an absolute difference between horizontal coordinates of upper-left vertexes of the reference block and the matching block is less than or equal to a first threshold, an absolute difference between vertical coordinates of the upper-left vertexes of the reference block and the matching block is greater than a second threshold, and a difference between the vertical coordinates of the upper-left vertexes of the reference block and the matching block is greater than 0. The fifth quantity may be selected from 1, 2, 3, 4, 5, and 6. The first threshold may be a difference between a half of a quantity of taps used by the interpolation filter in a horizontal direction and a specified constant. The second threshold may be a difference between a half of a quantity of taps used by the interpolation filter in a vertical direction and a specified constant. The specified constants may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the fifth quantity may be 1; or if the quantity of taps is 6, the fifth quantity may be 2; or if the quantity of taps is 8, the fifth quantity may be 3; or if the quantity of taps is 12, the fifth quantity may be 5.

In some embodiments, a pixel area with a sixth quantity of rows located below the search area is used as the range of the interpolation extension area, if an absolute difference between horizontal coordinates of upper-left vertexes of the reference block and the matching block is less than or equal to a first threshold, an absolute difference between vertical coordinates of the upper-left vertexes of the reference block and the matching block is greater than a second threshold, and a difference between the vertical coordinates of the upper-left vertexes of the reference block and the matching block is less than or equal to 0. The sixth quantity may be selected from 1, 2, 3, 4, 5, and 6. The first threshold may be a difference between a half of a quantity of taps used by the interpolation filter in a horizontal direction and a first specified constant. The second threshold may be a difference between a half of a quantity of taps used by the interpolation filter in a vertical direction and a second specified constant. The first specified constant and the second specified constant may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the sixth quantity may be 2; or if the quantity of taps is 6, the sixth quantity may be 3; or if the quantity of taps is 8, the sixth quantity may be 4; or if the quantity of taps is 12, the sixth quantity may be 6.

In some embodiments, extending the search area to obtain the interpolation extension area may be using a pixel area with a seventh quantity of columns located to the left of the search area and a pixel area with an eighth quantity of columns located to the right of the search area as the range of the interpolation extension area, if the absolute difference between the vertical coordinates of the upper-left vertexes of the reference block and the matching block is less than or equal to a third threshold, and the absolute difference between the horizontal coordinates of the upper-left vertexes of the reference block and the matching block is greater than a fourth threshold. The seventh quantity and the eighth quantity may be equal, or may not be equal. For example, the seventh quantity and the eighth quantity may be selected from 1, 2, 3, 4, 5, and 6. The third threshold may be a difference between the half of the quantity of taps used by the interpolation filter in the vertical direction and a third specified constant. The fourth threshold may be a difference between the half of the quantity of taps used by the interpolation filter in the horizontal direction and a fourth specified constant. The third specified constant and the fourth specified constant may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the seventh quantity may be 1, and the eighth quantity may be 2; or if the quantity of taps is 6, the seventh quantity may be 2, and the eighth quantity may be 3; or if the quantity of taps is 8, the seventh quantity may be 3, and the eighth quantity may be 4; or if the quantity of taps is 12, the seventh quantity may be 5, and the eighth quantity may be 6.

In some embodiments, a pixel area with a seventh quantity of columns located to the left of the search area is used as the range of the interpolation extension area, if the absolute difference between the vertical coordinates of the upper-left vertexes of the reference block and the matching block is less than or equal to a third threshold, the absolute difference between the horizontal coordinates of the upper-left vertexes of the reference block and the matching block is greater than a fourth threshold, and a difference between the horizontal coordinates of the upper-left vertexes of the reference block and the matching block is greater than 0. The seventh quantity may be selected from 1, 2, 3, 4, 5, and 6. The third threshold may be a difference between the half of the quantity of taps used by the interpolation filter in the vertical direction and a third specified constant. The fourth threshold may be a difference between the half of the quantity of taps used by the interpolation filter in the horizontal direction and a fourth specified constant. The third specified constant and the fourth specified constant may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the seventh quantity may be 1; or if the quantity of taps is 6, the seventh quantity may be 2; or if the quantity of taps is 8, the seventh quantity may be 3; or if the quantity of taps is 12, the seventh quantity may be 5.

In some embodiments, a pixel area with an eighth quantity of columns located to the right of the search area is used as the range of the interpolation extension area, if the absolute difference between the vertical coordinates of the upper-left vertexes of the reference block and the matching block is less than or equal to a third threshold, the absolute difference between the horizontal coordinates of the upper-left vertexes of the reference block and the matching block is greater than a fourth threshold, and a difference between the horizontal coordinates of the upper-left vertexes of the reference block and the matching block is less than or equal to 0. The eighth quantity may be selected from 1, 2, 3, 4, 5, and 6. The third threshold may be a difference between the half of the quantity of taps used by the interpolation filter in the vertical direction and a third specified constant. The fourth threshold may be a difference between the half of the quantity of taps used by the interpolation filter in the horizontal direction and a fourth specified constant. The third specified constant and the fourth specified constant may be, for example, 1 or other values. The quantity of taps used by the interpolation filter in the horizontal direction and the quantity of taps used by the interpolation filter in the vertical direction may be equal, or may not be equal.

For example, if the quantity of taps is 4, the eighth quantity may be 2; or if the quantity of taps is 6, the eighth quantity may be 3; or if the quantity of taps is 8, the eighth quantity may be 4; or if the quantity of taps is 12, the eighth quantity may be 6.

In some embodiments, extending the search area to obtain the interpolation extension area may be using the pixel area with the fifth quantity of rows located above the search area, the pixel area with the sixth quantity of rows located below the search area, the pixel area with the seventh quantity of columns located to the left of the search area, and the pixel area with the eighth quantity of columns located to the right of the search area as the range of the interpolation extension area, if the absolute difference between the horizontal coordinates of the upper-left vertexes of the reference block and the matching block is greater than a fifth threshold, and the absolute difference between the vertical coordinates of the upper-left vertexes of the reference block and the matching block is greater than a sixth threshold. The fifth quantity, the sixth quantity, the seventh quantity, and the eighth quantity may be equal, or may not be equal, or may be partially equal. For example, the fifth quantity, the sixth quantity, the seventh quantity, and the eighth quantity may be selected from 1, 2, 3, 4, 5, and 6. The fifth threshold may be a difference between the half of the quantity of taps used by the interpolation filter in the horizontal direction and a fifth specified constant. The sixth threshold may be a difference between the half of the quantity of taps used by the interpolation filter in the vertical direction and a sixth specified constant. The specified constants may be, for example, 1 or other values. The quantity of taps used by the interpolation filter in the horizontal direction and the quantity of taps used by the interpolation filter in the vertical direction may be equal, or may not be equal.

In some embodiments, the pixel area with the fifth quantity of rows located above the search area is used as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the vertical coordinates of the upper-left vertexes of the reference block and the matching block is greater than 0. The fifth quantity may be selected from 1, 2, 3, 4, 5, and 6. The fifth threshold may be a difference between the half of the quantity of taps used by the interpolation filter in the horizontal direction and a fifth specified constant. The sixth threshold may be a difference between the half of the quantity of taps used by the interpolation filter in the vertical direction and a sixth specified constant. The fifth specified constant and the sixth specified constant may be, for example, 1 or other values. The quantity of taps used by the interpolation filter in the horizontal direction and the quantity of taps used by the interpolation filter in the vertical direction may be equal, or may not be equal.

In some embodiments, the pixel area with the sixth quantity of rows located below the search area is used as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the vertical coordinates of the upper-left vertexes of the reference block and the matching block is less than or equal to 0. The sixth quantity may be selected from 1, 2, 3, 4, 5, and 6. The fifth threshold may be a difference between the half of the quantity of taps used by the interpolation filter in the horizontal direction and a fifth specified constant. The sixth threshold may be a difference between the half of the quantity of taps used by the interpolation filter in the vertical direction and a sixth specified constant. The fifth specified constant and the sixth specified constant may be, for example, 1 or other values. The quantity of taps used by the interpolation filter in the horizontal direction and the quantity of taps used by the interpolation filter in the vertical direction may be equal, or may not be equal.

In some embodiments, the pixel area with the seventh quantity of columns located to the left of the search area is used as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the horizontal coordinates of the upper-left vertexes of the reference block and the matching block is greater than 0. The seventh quantity may be selected from 1, 2, 3, 4, 5, and 6. The fifth threshold may be a difference between the half of the quantity of taps used by the interpolation filter in the horizontal direction and a fifth specified constant. The sixth threshold may be a difference between the half of the quantity of taps used by the interpolation filter in the vertical direction and a sixth specified constant. The fifth specified constant and the sixth specified constant may be, for example, 1 or other values. The quantity of taps used by the interpolation filter in the horizontal direction and the quantity of taps used by the interpolation filter in the vertical direction may be equal, or may not be equal.

In some embodiments, the pixel area with the eighth quantity of columns located to the right of the search area is used as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the horizontal coordinates of the upper-left vertexes of the reference block and the matching block is less than or equal to 0. The eighth quantity may be selected from 1, 2, 3, 4, 5, and 6. The fifth threshold may be a difference between the half of the quantity of taps used by the interpolation filter in the horizontal direction and a fifth specified constant. The sixth threshold may be a difference between the half of the quantity of taps used by the interpolation filter in the vertical direction and a sixth specified constant. The specified constants may be, for example, 1 or other values. The quantity of taps used by the interpolation filter in the horizontal direction and the quantity of taps used by the interpolation filter in the vertical direction may be equal, or may not be equal.

The upper-left vertexes in the foregoing embodiments are examples. Upper-right vertexes, lower-left vertexes, lower-right vertexes, and block central points of the reference block and the matching block may be used, or coordinates at any same positions in the reference block and the matching block may be used.

Based on the foregoing embodiment, it is assumed that coordinates of the current block (for example, coordinates of an upper-left vertex of the current block) are (x, y), the current block has a width of w and a height of h, and an initial MV and a best MV for inter-frame template matching are respectively

$$( {mv}_{x}^{1} , {mv}_{y}^{1} ) and ( {mv}_{x}^{2} , {mv}_{y}^{2} ) .$$

The initial MV corresponds to the reference block, and the best MV corresponds to a best matching block. In this case, because positions of the reference block and the best matching block are different, the interpolation extension area may be determined in the following manners.

$$When \vert {mv}_{x}^{1} - {mv}_{x}^{2} \vert \leq \frac{{T}_{1}}{2} - 1 , and \vert {mv}_{y}^{1} - {mv}_{y}^{2} \vert > \frac{{T}_{2}}{2} - 1 ,$$

the interpolation extension area may be obtained by extending the search area upward only by I pixels (to be specific, I rows of pixels) and downward only by J pixels (to be specific, J rows of pixels). Under the foregoing condition, when

$$m {v}_{y}^{1} - m {v}_{y}^{2} > 0 ,$$

the search area may be extended upward only by I pixels; or when

$$m {v}_{y}^{1} - m {v}_{y}^{2} \leq 0 ,$$

the search area may be extended downward only by J pixels.

When

$${mv}_{y}^{1} - {mv}_{y}^{2} \vert \leq \frac{{T}_{2}}{2} - 1 ,$$

$$and$$

$$\vert {mv}_{y}^{1} - {mv}_{y}^{2} \vert > \frac{{T}_{1}}{2} - 1 ,$$

the interpolation extension area may be obtained by extending the search area leftward only by I pixels (to be specific, I columns of pixels) and rightward only by J pixels (to be specific, J columns of pixels). Under the foregoing condition, when

$${mv}_{x}^{1} - {mv}_{x}^{2} > 0 ,$$

the search area may be extended leftward only by I pixels; or when

$${mv}_{x}^{1} - {mv}_{x}^{2} \leq 0 ,$$

the search area may be extended rightward only by J pixels.

When

$$\vert {mv}_{y}^{1} - {mv}_{y}^{2} \vert > \frac{{T}_{1}}{2} - 1 ,$$

$$and$$

$$\vert {mv}_{y}^{1} - {mv}_{y}^{2} \vert > \frac{{T}_{2}}{2} - 1 ,$$

the interpolation extension area may be obtained by respectively extending the search area upward by I1 pixels (to be specific, I1 rows of pixels), downward by J1 pixels (to be specific, J1 rows of pixels), leftward by I2 pixels (to be specific, I2 columns of pixels), and rightward by J2 pixels (to be specific, J2 columns of pixels). Under the foregoing condition, when

$${mv}_{x}^{1} - {mv}_{x}^{2} > 0 ,$$

the search area may be extended leftward only by I2 pixels. Under the foregoing condition, when

$${mv}_{x}^{1} - {mv}_{x}^{2} \leq 0 ,$$

the search area may be extended rightward only by J2 pixels. Under the foregoing condition, when

$${mv}_{y}^{1} - {mv}_{y}^{2} > 0 ,$$

the search area may be extended upward only by I1 pixels. Under the foregoing condition, when

$${mv}_{y}^{1} - {mv}_{y}^{2} \leq 0 ,$$

the search area may be extended downward only by J1 pixels.

When

$$\vert {mv}_{x}^{1} - {mv}_{x}^{2} \vert \leq \frac{{T}_{1}}{2} - 1 ,$$

$$and$$

$$\vert {mv}_{y}^{1} - {mv}_{y}^{2} \vert \leq \frac{{T}_{2}}{2} - 1 ,$$

the interpolation extension area is not outside a boundary of the search area, that is, pixel extension does not need to be performed.

In the foregoing example, I, J, I1, J1, I2, and J2 are all positive integers. T₁ represents the quantity of taps of the interpolation filter in the horizontal direction. T₂ represents the quantity of taps of the interpolation filter in the vertical direction.

In this embodiment of this disclosure, if the interpolation extension area is determined based on the range of the search area, the range of the interpolation extension area may be determined by using at least one of the following areas: a pixel area with a ninth quantity of rows located above the search area; a pixel area with a tenth quantity of rows located below the search area; a pixel area with an eleventh quantity of columns located to the left of the search area; a pixel area with a twelfth quantity of columns located to the right of the search area; a pixel area located to the upper left of the search area; a pixel area located to the upper right of the search area; a pixel area located to the lower left of the search area; and a pixel area located to the lower right of the search area.

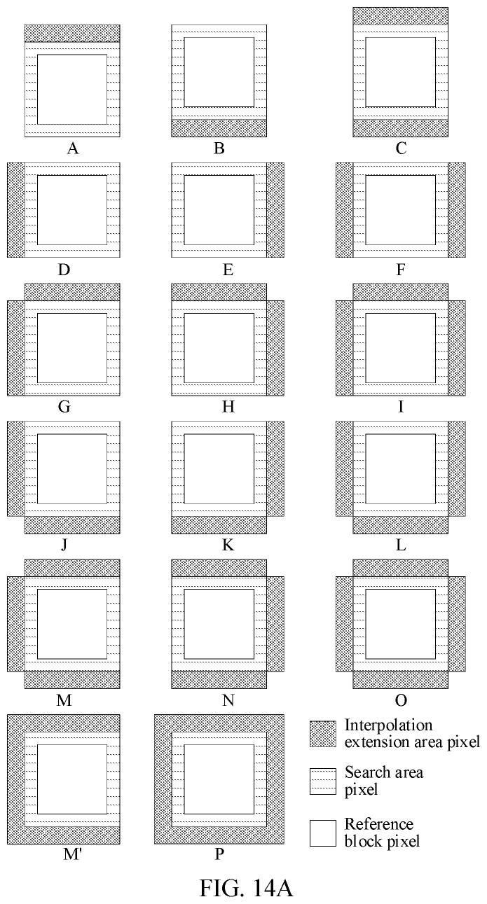

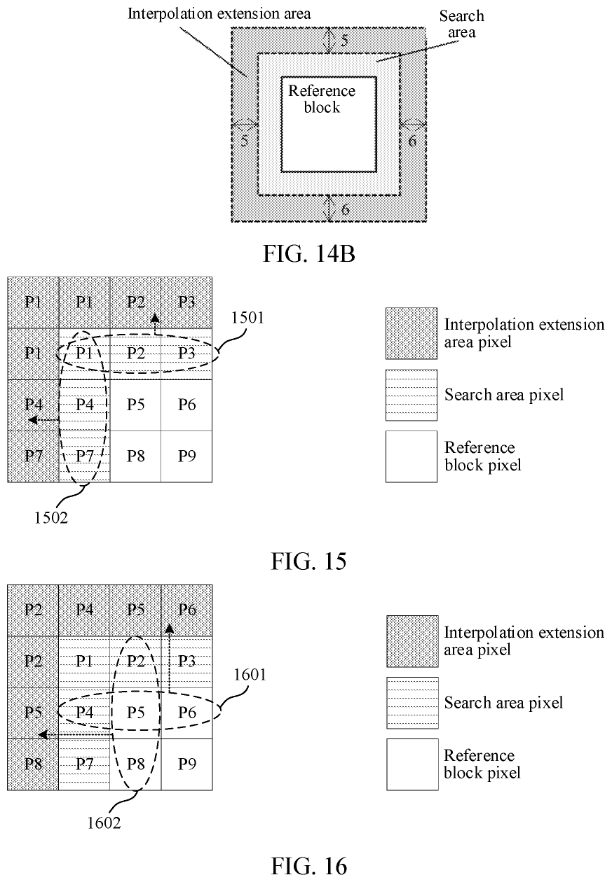

As shown in FIG. 14A, the interpolation extension area may be arranged in a plurality of modes. The arrangement modes in FIG. 14A are described by using an example in which the search area surrounds the reference block, and the modes in FIG. 14A are merely an example. As shown in FIG. 14A, the interpolation extension area may be at least located above the search area, located below the search area, located to the left of the search area, or located to the right of the search area. The interpolation extension area may further include pixel areas at one or more of an upper-left corner, an upper-right corner, a lower-left corner, and a lower-right corner in a mode A to a mode O shown in FIG. 14A. As shown in FIG. 14A, the mode M is used as an example. If the interpolation extension area includes the pixel areas at the upper-left corner and the lower-left corner, the interpolation extension area may be shown as a mode M′ in FIG. 14A. For another example, as shown by the mode O in FIG. 14A, if the interpolation extension area includes the pixel areas at the upper-left corner, the upper-right corner, the lower-left corner, and the lower-right corner, the interpolation extension area may be shown in a mode P shown in FIG. 14A.

In a specific example, as shown in FIG. 14B, the search area surrounds the reference block, and the interpolation extension area is an area formed by respectively extending the search area upward by five pixels (to be specific, five rows of pixels) and leftward by five pixels (to be specific, five columns of pixels), and respectively extending the search area downward by six pixels (to be specific, six rows of pixels) and rightward by six pixels (to be specific, six columns of pixels).

The search area may further include the pixel areas at the upper-left corner, the upper-right corner, the lower-left corner, and the lower-right corner in the modes A to O shown in FIG. 13. As shown in FIG. 13, the mode Mis used as an example. If the search area includes the pixel areas at the upper-left corner and the lower-left corner, the search area may be shown in the mode M′ in FIG. 13.

In some embodiments of this disclosure, if the interpolation extension area is determined based on the quantity of taps of the interpolation filter, when the quantity of taps of the interpolation filter is 4, a pixel area with one row located above the search area, a pixel area with two rows located below the search area, a pixel area with one column located to the left of the search area, and a pixel area with two columns located to the right of the search area are used as the range of the interpolation extension area. Specific values in the embodiments are examples.

In some embodiments of this disclosure, if the interpolation extension area is determined based on the quantity of taps of the interpolation filter, when the quantity of taps of the interpolation filter is 6, a pixel area with two rows located above the search area, a pixel area with three rows located below the search area, a pixel area with two columns located to the left of the search area, and a pixel area with three columns located to the right of the search area are used as the range of the interpolation extension area. Specific values in the embodiments are examples.

In some embodiments of this disclosure, if the interpolation extension area is determined based on the quantity of taps of the interpolation filter, when the quantity of taps of the interpolation filter is 8, a pixel area with three rows located above the search area, a pixel area with four rows located below the search area, a pixel area with three columns located to the left of the search area, and a pixel area with four columns located to the right of the search area are used as the range of the interpolation extension area. Specific values in the embodiments are examples.

In some embodiments of this disclosure, if the interpolation extension area is determined based on the quantity of taps of the interpolation filter, when the quantity of taps of the interpolation filter is 12, a pixel area with five rows located above the search area, a pixel area with six rows located below the search area, a pixel area with five columns located to the left of the search area, and a pixel area with six columns located to the right of the search area are used as the range of the interpolation extension area. Specific values in the embodiments are examples.

In some embodiments of this disclosure, if the interpolation extension area is determined based on the quantity of taps of the interpolation filter, when the quantity of taps of the interpolation filter is 12, a pixel area with five columns located to the left of the search area and a pixel area with six columns located to the right of the search area are used as the range of the interpolation extension area. Specific values in the embodiments are examples.

In some embodiments of this disclosure, if the interpolation extension area is determined based on the quantity of taps of the interpolation filter, when the quantity of taps of the interpolation filter is 12, a pixel area with five rows located above the search area and a pixel area with six rows located below the search area are used as the range of the interpolation extension area. Specific values in the embodiments are examples.

In some embodiments, if a coordinate position of the reference block is outside an image boundary of the reference frame, the coordinate position of the reference block may be adjusted to be at the image boundary. The image boundary of the reference frame may be a boundary of the reference frame of image, or may be a boundary obtained by extending the reference frame of image outward by an area with a specified size (for example, a specified quantity of rows and/or a specified quantity of columns).

In some embodiments, if a coordinate position of the matching block is outside an image boundary of the reference frame, the coordinate position of the matching block may be adjusted to be at the image boundary. The image boundary of the reference frame may be a boundary of the reference frame of image, or may be a boundary obtained by extending the reference frame of image outward by an area with a specified size (for example, a specified quantity of rows and/or a specified quantity of columns).

In some embodiments, if the search area is outside an image boundary of the reference frame, the boundary of the search area may be adjusted to be at the image boundary. The image boundary of the reference frame may be a boundary of the reference frame of image, or may be a boundary obtained by extending the reference frame of image outward by an area with a specified size (for example, a specified quantity of rows and/or a specified quantity of columns).

In some examples, it is assumed that coordinates of the current block (for example, coordinates of an upper-left vertex of the current block) are (x, y), the current block has a width of w and a height of h, and an initial MV and a best MV for inter-frame template matching are respectively

$$( {mv}_{x}^{1} , {mv}_{y}^{1} )$$

$$and$$

$$( {mv}_{x}^{2} , {mv}_{y}^{2} ) .$$

In this case, upper-left coordinates, upper-right coordinates, lower-left coordinates, and lower-right coordinates of the reference block of the current block are respectively

$$( x + {mv}_{x}^{1} , y + {mv}_{y}^{1} ) , ( x + w + {mv}_{x}^{1} , y + {mv}_{y}^{1} ) , ( x + {mv}_{x}^{1} , y + h + {mv}_{y}^{1} ) ,$$

$$and$$

$$( x + w + {mv}_{x}^{1} , y + h + {mv}_{y}^{1} ) ,$$

and upper-left coordinates, upper-right coordinates, lower-left coordinates, and lower-right coordinates of a best matching block corresponding to the best MV are respectively

$$( x + {mv}_{x}^{2} , y + {mv}_{y}^{2} ) , ( x + w + {mv}_{x}^{2} , y + {mv}_{y}^{2} ) , ( x + {mv}_{x}^{2} , y + h + {mv}_{y}^{2} ) ,$$

$$and$$

$$( x + w + {mv}_{x}^{2} , y + h + {mv}_{y}^{2} ) .$$

Therefore, none of these coordinate values can be outside an image boundary, which may also be understood as that neither the reference block nor the best matching block can be outside the image boundary. The image boundary may be a boundary of a current encoded image (a current frame), or a boundary obtained by extending the current encoded image outward by a unit of N1 pixel, where N1 is a positive integer (for example, a boundary obtained by extending the current encoded image outward by a length of one CTU).

If none of the coordinates of the reference block and the coordinates of the best matching block is outside the image boundary, template matching and pixel interpolation may be performed based on positions of the reference block and the best matching block. Otherwise, coordinates that are outside the image boundary are adjusted to the boundary of the current encoded image. In addition, the coordinates of the best matching block may be at the boundary of the search area, and therefore, the boundary of the search area cannot be outside the image boundary either.

In some embodiments, when the pixel value in the interpolation extension area configured for performing interpolation filtering processing is determined based on the pixel value in the specified area in the reference frame, the specified area in the reference frame may be arranged according to an actual requirement. For example, the specified area may include at least one of the following areas: a first pixel position in the search area, and a second pixel position in the reference block of the current block. The first pixel position may be a position with one pixel, or may be a position with a plurality of pixels. The second pixel position may be a position with one pixel, or may be a position with a plurality of pixels.

In some embodiments, when the pixel value in the interpolation extension area is determined, the pixel value in the specified area may be copied as the pixel value in the interpolation extension area. For example, several pixel values are copied to fill a specified position in the interpolation extension area. The interpolation extension area may include one or more sub-interpolation extension areas. Copying the pixel value in the specified area as the pixel value in the interpolation extension area may include: determining a size and a position of a sub-interpolation extension area; and selecting, in the specified area, a pixel value in an area whose size is the same as that of the sub-interpolation extension area, as a pixel value at a corresponding position in the sub-interpolation extension area.

As shown in FIG. 15, pixel values at a position 1501 in the search area and pixel values at a position 1502 in the search area may be copied as pixel values at a corresponding position in the interpolation extension area. In addition, a pixel value at an upper-left corner of the interpolation extension area may be obtained by copying a pixel value at a specified position (for example, a pixel at an upper-left corner of the search area or a position that is in the interpolation extension area and that is adjacent to an upper-left corner of the interpolation extension area). For example, the interpolation extension area may include an upper interpolation extension area located above the search area, a left interpolation extension area located to the left of the search area, and an upper-left interpolation extension area located to the upper left of the search area. A row of pixel values P1, P2, and P3, in the search area, at the position 1501 adjacent to the upper interpolation extension area may be copied as a corresponding row of pixel values in the upper interpolation extension area, and a column of pixel values P1, P4, and P7, in the search area, at the position 1502 adjacent to the left interpolation extension area may be copied as a corresponding column of pixel values in the left interpolation extension area. In addition, a pixel value P1 at a pixel position at an upper-left corner of the search area or a pixel position that is adjacent to the upper-left interpolation extension area and that is in another interpolation extension area (for example, the upper or left interpolation extension area) may be copied as a pixel value of the upper-left interpolation extension area.

Alternatively, as shown in FIG. 16, not only the pixel value in the search area, but also a pixel value in the reference block may be copied as pixel values at a corresponding position in the interpolation extension area. For example, a pixel value at a position 1601 and a pixel value at a position 1602 in an area formed by the search area and the reference block may be copied as pixel values at a corresponding position in the interpolation extension area. In addition, a pixel value at an upper-left corner of the interpolation extension area may be obtained by copying a pixel value at a specified position (for example, a pixel value at a position in the search area). For example, the interpolation extension area may include an upper interpolation extension area located above the search area, a left interpolation extension area located to the left of the search area, and an upper-left interpolation extension area located to the upper left of the search area. A row of pixel values P4, P5, and P6, in an area formed by the search area and the reference block, at a position 1601 next-nearest to the upper interpolation extension area may be copied as a corresponding row of pixel values in the upper interpolation extension area, and a column of pixel values P2, P5, and P8, in the area formed by the search area and the reference block, at a position 1602 next-nearest to the left interpolation extension area may be copied as a corresponding column of pixel values in the left interpolation extension area. A pixel value, in the search area, at a position closest to the interpolation extension area in the position 1602 may be copied as a pixel value in the upper left interpolation extension area.

In some embodiments, when the pixel value in the interpolation extension area is determined, symmetry axis-based symmetric processing may be performed on the pixel value in the specified area to obtain the pixel value in the interpolation extension area. The interpolation extension area may be partitioned into one or more sub-interpolation extension areas in an upper interpolation extension area located above the search area, a lower interpolation extension area located below the search area, a left interpolation extension area located to the left of the search area, and a right interpolation extension area located to the right of the search area. The one or more sub-interpolation extension areas may be non-corner interpolation extension areas that are not at corners of the search area. Performing symmetry axis-based symmetric processing on the pixel value in the specified area to obtain the pixel value in the interpolation extension area may include, for example, determining a size and a position of a sub-interpolation extension area; selecting, in the specified area based on a symmetry axis, a pixel value in an area that is symmetrical to and has the same size as the sub-interpolation extension area, as a pixel value at a corresponding position in the sub-interpolation extension area. The symmetry axis is, for example, a boundary between the search area and the interpolation extension area, or a boundary of the reference block that is closest to the sub-interpolation extension area.

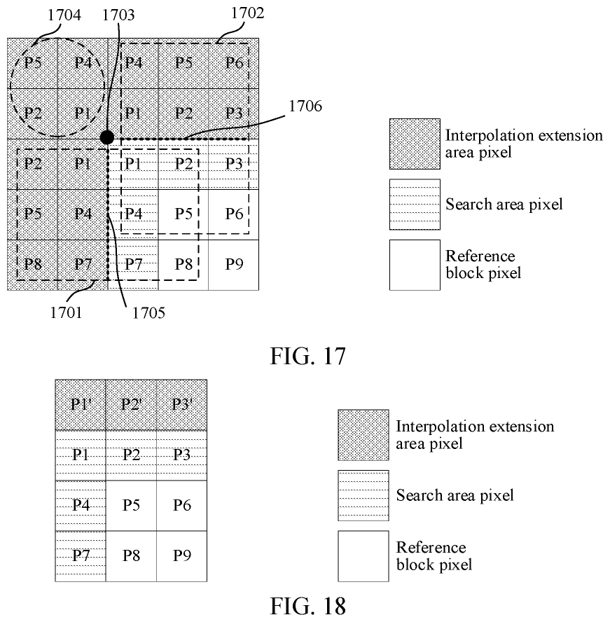

As shown in FIG. 17, symmetric processing is performed in a rectangular dashed box 1701 to obtain a pixel value at a corresponding position in the interpolation extension area, and symmetric processing is performed in a rectangular dashed box 1702 to obtain a pixel value at a corresponding position in the interpolation extension area. For example, in the rectangular dashed box 1701, a size (including three rows and two columns of pixels) and a position (for example, a pixel position at an upper-left corner of a sub-interpolation extension area) of the sub-interpolation extension area may be determined, a boundary 1705 between the sub-interpolation extension area and the search area is used as a symmetry axis, and pixel values P1, P2, P4, P5, P7, and P8 in an area that is symmetrical to and has the same size as the sub-interpolation extension area are selected, from the specified area formed by the search area and the reference block, as pixel values at a corresponding position in the sub-interpolation extension area. In the rectangular dashed box 1702, a size (including two rows and three columns of pixels) and a position (for example, a pixel position at an upper-left corner of a sub-interpolation extension area) of the sub-interpolation extension area may be determined, a boundary 1706 between the sub-interpolation extension area and the search area is used as a symmetry axis, and pixel values P1, P2, P3, P4, P5, and P6 in an area that is symmetrical to and has the same size as the sub-interpolation extension area are selected, from the specified area formed by the search area and the reference block, as pixel values at a corresponding position in the sub-interpolation extension area.

In some embodiments, when the pixel value in the interpolation extension area is determined, symmetry point-based symmetric processing may be performed on the pixel value in the specified area to obtain the pixel value in the interpolation extension area. The interpolation extension area may include sub-interpolation extension areas at one or more corners of the search area, such as an upper-left corner, an upper-right corner, a lower-left corner, and a lower-right corner. Performing symmetry point-based symmetric processing on the pixel value in the specified area to obtain the pixel value in the interpolation extension area may include determining a size and a position of a sub-interpolation extension area; selecting, in the specified area based on a symmetry point, a pixel value in an area that is symmetrical to and has the same size as the sub-interpolation extension area, as a pixel value at a corresponding position in the sub-interpolation extension area. The symmetry point is, for example, a pixel at a corner of the search area corresponding to the sub-interpolation extension area, or a pixel at a corner of the reference block corresponding to the sub-interpolation extension area.

As shown in FIG. 17, pixel values in a circular dashed box 1704 are obtained by performing symmetric processing based on a symmetry point 1703. For example, in the circular dashed box 1704, a size (including two rows and two columns of pixels) and a position (for example, a pixel position at an upper-left corner of a sub-interpolation extension area) of the sub-interpolation extension area may be determined. A pixel 1703 at a corner of the search area corresponding to the sub-interpolation extension area is used as a symmetry point, and pixel values P1, P2, P4, and P5 in an area that is symmetrical to and has the same size as the sub-interpolation extension area are selected, from the specified area formed by the search area and the reference block, as pixel values at a corresponding position in the sub-interpolation extension area.

In some embodiments, when the pixel value in the interpolation extension area is determined, weighting calculation may be performed on the pixel value in the specified area to obtain the pixel value in the interpolation extension area. As shown in FIG. 18, in the interpolation extension area, a pixel value P1′=(2*P4+P1+P7+2)>>2; in the interpolation extension area, a pixel value P2′=(2*P5+P2+P8+2)>>2; and in the interpolation extension area, a pixel value P3′=(2*P6+P3+P9+2)>>2.

In some embodiments, when the pixel value in the interpolation extension area is determined, intra-frame prediction processing may be performed based on the pixel value in the specified area to obtain the pixel value in the interpolation extension area. For example, pixel values at a corresponding position in the interpolation extension area may be filled based on calculation formulas of an angle mode, a DC mode, and a planar mode.

The foregoing embodiments of determining the pixel value in the interpolation extension area may be used in combination, or may be used independently.

In some embodiments, in the interpolation extension area, pixel values of pixels in an upper-left area may be obtained by copying a pixel value of an upper pixel located in an upper area and a pixel value of a left pixel located in a left area in the interpolation extension area, or may be obtained in another manner such as performing symmetric processing on the upper pixel and the left pixel, or may be obtained by performing weighting calculation on the pixel value of the upper pixel and the pixel value of the left pixel, or may be obtained by performing intra-frame prediction based on these pixel values. In the interpolation extension area, pixel values of pixels in an upper-right area may be obtained by copying a pixel value of an upper pixel and a pixel value of a right pixel located in a right area in the interpolation extension area, or may be obtained in another manner such as performing symmetric processing on the upper pixel and the right pixel, or may be obtained by performing weighting calculation on the pixel value of the upper pixel and the pixel value of the right pixel, or may be obtained by performing intra-frame prediction based on these pixel values. In the interpolation extension area, pixel values of pixels in a lower-left area may be obtained by copying a pixel value of a lower pixel located in a lower area and a pixel value of a left pixel located in a left area in the interpolation extension area, or may be obtained in a manner such as performing symmetric processing on the lower pixel and the left pixel, or may be obtained by performing weighting calculation on the pixel value of the lower pixel and the pixel value of the left pixel, or may be obtained by performing intra-frame prediction based on these pixel values. In the interpolation extension area, pixel values of pixels in a lower-right area may be obtained by copying a pixel value of a lower pixel located in a lower area and a pixel value of a right pixel located in a right area in the interpolation extension area, or may be obtained in another manner such as performing symmetric processing on the lower pixel and the right pixel, or may be obtained by performing weighting calculation on the pixel value of the lower pixel and the pixel value of the right pixel, or may be obtained in a manner such as performing intra-frame prediction based on these pixel values. A symmetry axis for symmetric processing is, for example, a boundary between pixels. Alternatively, symmetric processing is performed by using a pixel in the interpolation extension area as a symmetry point.

S1240: Perform interpolation filtering processing on the matching block based on the interpolation extension area.

In some embodiments, after interpolation filtering processing is performed on the matching block based on the interpolation extension area, a best matching block of the current block may be obtained, and then the best matching block may be used as a predicted block of the current block to continue to perform decoding.

In some embodiments, when the technical solution in this embodiment of this disclosure is applied, a decoder side may determine at least one of the following information based on a default manner negotiated with an encoder side: the range of the search area, the range of the interpolation extension area, and the pixel value in the interpolation extension area. That is, in this embodiment, the encoder side and the decoder side may be enabled to use the same manner by default based on an implicit application. For example, the encoder side and the decoder side both consider, by default, that the search area is obtained by extending N3 pixels (where N3 is a positive integer) from the reference block to the periphery, the interpolation extension area is obtained by extending the search area leftward by five pixels (to be specific, five columns) and upward by five pixels (to be specific, five rows), extending the search area rightward by six pixels (to be specific, six columns) and downward by six pixels (to be specific, six rows), and the interpolation extension area is filled in a copying manner.

In some embodiments, when the technical solution in this embodiment of this disclosure is applied, at least one flag bit may be obtained by decoding the video bitstream, and then at least one of the following information is determined based on a value of the at least one flag bit: the range of the search area, the range of the interpolation extension area, and the pixel value in the interpolation extension area. For example, the encoder side may adaptively choose, through RDO, whether to use one or more of the manners provided in this embodiment of this disclosure, and indicate a specific manner by using one or more of a block-level flag bit, a CTU-level flag bit, a slice-level flag bit, and a frame-level flag bit, so that the decoder side can directly parse the flag bit and obtain a corresponding processing manner. In some examples, for example, the encoder side may use three flag bits. A value of one flag bit indicates the range of the search area (for example, indicates how many pixels are extended from the reference block to the periphery to obtain the search area), a value of one flag bit indicates the range of the interpolation extension area, and a value of one flag bit indicates how to determine the pixel value in the interpolation extension area.

In some embodiments, the encoder side may implicitly indicate, by adjusting a quantization coefficient, one or more manners to be used by the decoder side. In this way, the decoder side determines an implicitly exported flag bit by collecting statistics on the quantization coefficient, to determine a corresponding processing manner.

The solutions in the foregoing embodiments of this disclosure may be used independently, or may be used in combination. The technical solutions in the embodiments of this disclosure may be applied to a search process and/or a motion compensation process that are/is based on template matching technologies such as an intra-frame technology and an inter-frame technology, and may be applied to a video codec product.

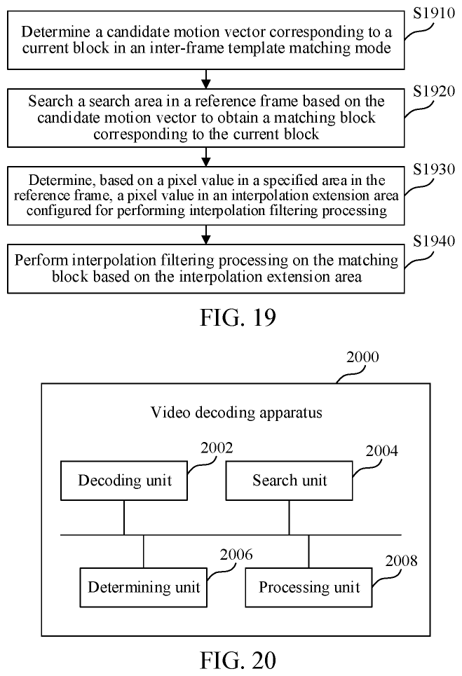

FIG. 19 is a flowchart of a video encoding method according to an embodiment of this disclosure. The video encoding method may be performed by a device having a computing processing function, for example, may be performed by a terminal device or a server. Referring to FIG. 19, the video encoding method includes at least S1910 to S1940, and details are described as follows.

S1910: Determine a candidate motion vector of a current block in an inter-frame template matching mode.

S1920: Search a search area in a reference frame based on the candidate motion vector to obtain a matching block of the current block.

S1930: Determine, based on a pixel value in a specified area in the reference frame, a pixel value in an interpolation extension area configured for performing interpolation filtering processing on the matching block. The interpolation extension area is an area that is in the reference frame and that is extended based on the search area.

S1940: Perform interpolation filtering processing on the matching block based on the interpolation extension area to perform encoding based on a result of interpolation filtering processing.

A processing process on an encoder side is similar to a processing process on a decoder side. For details, refer to the foregoing processing process on the decoder side, and details are not described herein again.

Apparatus embodiments of this disclosure are described below, which may be configured to perform the method in the foregoing embodiments of this disclosure. For details not disclosed in the apparatus embodiments of this disclosure, refer to the foregoing method embodiments of this disclosure.

FIG. 20 is a block diagram of a video decoding apparatus according to an embodiment of this disclosure. The video decoding apparatus may be disposed in a device having a computing processing function, for example, may be disposed in a terminal device or a server.

Referring to FIG. 20, the video decoding apparatus 2000 according to this embodiment of this disclosure includes a decoding unit 2002, a search unit 2004, a determining unit 2006, and a processing unit 2008.

The decoding unit 2002 is configured to decode a video bitstream to obtain a candidate motion vector of a current block in an inter-frame template matching mode. The search unit 2004 is configured to search a search area in a reference frame based on the candidate motion vector to obtain a matching block of the current block. The determining unit 2006 is configured to determine, based on a pixel value in a specified area in the reference frame, a pixel value in an interpolation extension area configured for performing interpolation filtering processing on the matching block. The processing unit 2008 is configured to perform interpolation filtering processing on the matching block based on the interpolation extension area. The interpolation extension area is an area that is in the reference frame and that is extended based on the search area.

In some embodiments of this disclosure, based on the foregoing solutions, the search unit 2004 is configured to: determine, in the reference frame, a reference block of the current block and a search start point in the search area based on the candidate motion vector; search, based on the search start point, the search area for a best motion vector corresponding to the candidate motion vector; and determine the matching block of the current block based on the best motion vector.

In some embodiments of this disclosure, based on the foregoing solutions, the search area includes at least one of the following areas:
a pixel area with a first quantity of rows located above the reference block;
a pixel area with a second quantity of rows located below the reference block;
a pixel area with a third quantity of columns located to the left of the reference block;
a pixel area with a fourth quantity of columns located to the right of the reference block;
a pixel area located to the upper left of the reference block;
a pixel area located to the upper right of the reference block;
a pixel area located to the lower left of the reference block; and
a pixel area located to the lower right of the reference block.

In some embodiments of this disclosure, based on the foregoing solutions, the determining unit 2006 is further configured to determine a range of the interpolation extension area based on at least one of the following information: a position of the matching block, a quantity of taps of an interpolation filter, and a range of the search area.

In some embodiments of this disclosure, based on the foregoing solutions, the determining unit 2006 is configured to extend the search area to obtain the interpolation extension area, if a pixel configured for performing interpolation filtering processing on the matching block is outside the range of the search area.

In some embodiments of this disclosure, based on the foregoing solutions, the determining unit 2006 is configured to extend the search area to obtain the interpolation extension area, including any one of the following manners:
using a pixel area with a fifth quantity of rows located above the search area and a pixel area with a sixth quantity of rows located below the search area as the range of the interpolation extension area, if an absolute difference between horizontal coordinates of upper-left vertexes of the reference block and the matching block is less than or equal to a first threshold, and an absolute difference between vertical coordinates of the upper-left vertexes of the reference block and the matching block is greater than a second threshold; or
using a pixel area with a fifth quantity of rows located above the search area as the range of the interpolation extension area, if an absolute difference between horizontal coordinates of upper-left vertexes of the reference block and the matching block is less than or equal to a first threshold, an absolute difference between vertical coordinates of the upper-left vertexes of the reference block and the matching block is greater than a second threshold, and a difference between the vertical coordinates of the upper-left vertexes of the reference block and the matching block is greater than 0; or
using a pixel area with a sixth quantity of rows located below the search area as the range of the interpolation extension area, if an absolute difference between horizontal coordinates of upper-left vertexes of the reference block and the matching block is less than or equal to a first threshold, an absolute difference between vertical coordinates of the upper-left vertexes of the reference block and the matching block is greater than a second threshold, and a difference between the vertical coordinates of the upper-left vertexes of the reference block and the matching block is less than or equal to 0,
the first threshold being a difference between a half of a quantity of taps used by the interpolation filter in a horizontal direction and a first specified constant, and the second threshold being a difference between a half of a quantity of taps used by the interpolation filter in a vertical direction and a second specified constant.

In some embodiments of this disclosure, based on the foregoing solutions, the determining unit 2006 is configured to extend the search area to obtain the interpolation extension area, including any one of the following manners:
using a pixel area with a seventh quantity of columns located to the left of the search area and a pixel area with an eighth quantity of columns located to the right of the search area as the range of the interpolation extension area, if the absolute difference between the vertical coordinates of the upper-left vertexes of the reference block and the matching block is less than or equal to a third threshold, and the absolute difference between the horizontal coordinates of the upper-left vertexes of the reference block and the matching block is greater than a fourth threshold; or
using a pixel area with a seventh quantity of columns located to the left of the search area as the range of the interpolation extension area, if the absolute difference between the vertical coordinates of the upper-left vertexes of the reference block and the matching block is less than or equal to a third threshold, the absolute difference between the horizontal coordinates of the upper-left vertexes of the reference block and the matching block is greater than a fourth threshold, and a difference between the horizontal coordinates of the upper-left vertexes of the reference block and the matching block is greater than 0; or
using a pixel area with an eighth quantity of columns located to the right of the search area as the range of the interpolation extension area, if the absolute difference between the vertical coordinates of the upper-left vertexes of the reference block and the matching block is less than or equal to a third threshold, the absolute difference between the horizontal coordinates of the upper-left vertexes of the reference block and the matching block is greater than a fourth threshold, and a difference between the horizontal coordinates of the upper-left vertexes of the reference block and the matching block is less than or equal to 0,
the third threshold being a difference between the half of the quantity of taps used by the interpolation filter in the horizontal direction and a third specified constant, and the fourth threshold being a difference between the half of the quantity of taps used by the interpolation filter in the vertical direction and a fourth specified constant.

In some embodiments of this disclosure, based on the foregoing solutions, the determining unit 2006 is configured to extend the search area to obtain the interpolation extension area, including any one of the following manners:
using the pixel area with the fifth quantity of rows located above the search area, the pixel area with the sixth quantity of rows located below the search area, the pixel area with the seventh quantity of columns located to the left of the search area, and the pixel area with the eighth quantity of columns located to the right of the search area as the range of the interpolation extension area, if the absolute difference between the horizontal coordinates of the upper-left vertexes of the reference block and the matching block is greater than a fifth threshold, and the absolute difference between the vertical coordinates of the upper-left vertexes of the reference block and the matching block is greater than a sixth threshold; or
using the pixel area with the fifth quantity of rows located above the search area as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the vertical coordinates of the upper-left vertexes of the reference block and the matching block is greater than 0; or
using the pixel area with the sixth quantity of rows located below the search area as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the vertical coordinates of the upper-left vertexes of the reference block and the matching block is less than or equal to 0; or
using the pixel area with the seventh quantity of columns located to the left of the search area as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the horizontal coordinates of the upper-left vertexes of the reference block and the matching block is greater than 0; or
using the pixel area with the eighth quantity of columns located to the right of the search area as the range of the interpolation extension area, if the absolute difference between the horizontal coordinates of the upper-left vertexes of the reference block and the matching block is greater than a fifth threshold, the absolute difference between the vertical coordinates of the upper-left vertexes of the reference block and the matching block is greater than a sixth threshold, and the difference between the horizontal coordinates of the upper-left vertexes of the reference block and the matching block is less than or equal to 0, the fifth threshold being a difference between the half of the quantity of taps used by the interpolation filter in the horizontal direction and a fifth specified constant, and the sixth threshold being a difference between the half of the quantity of taps used by the interpolation filter in the vertical direction and a sixth specified constant.

In some embodiments of this disclosure, based on the foregoing solutions, the determining unit 2006 is configured to determine the range of the interpolation extension area based on at least one of the following areas:
a pixel area with a ninth quantity of rows located above the search area;
a pixel area with a tenth quantity of rows located below the search area;
a pixel area with an eleventh quantity of columns located to the left of the search area;
a pixel area with a twelfth quantity of columns located to the right of the search area;
a pixel area located to the upper left of the search area;
a pixel area located to the upper right of the search area;
a pixel area located to the lower left of the search area; and
a pixel area located to the lower right of the search area.

In some embodiments of this disclosure, based on the foregoing solutions, the determining unit 2006 is configured to determine the range of the interpolation extension area based on at least one of the following manners:
if the quantity of taps of the interpolation filter is 4, using a pixel area with one row located above the search area, a pixel area with two rows located below the search area, a pixel area with one column located to the left of the search area, and a pixel area with two columns located to the right of the search area as the range of the interpolation extension area; or
if the quantity of taps of the interpolation filter is 6, using a pixel area with two rows located above the search area, a pixel area with three rows located below the search area, a pixel area with two columns located to the left of the search area, and a pixel area with three columns located to the right of the search area as the range of the interpolation extension area; or
if the quantity of taps of the interpolation filter is 8, using a pixel area with three rows located above the search area, a pixel area with four rows located below the search area, a pixel area with three columns located to the left of the search area, and a pixel area with four columns located to the right of the search area as the range of the interpolation extension area; or
if the quantity of taps of the interpolation filter is 12, using a pixel area with five rows located above the search area, a pixel area with six rows located below the search area, a pixel area with five columns located to the left of the search area, and a pixel area with six columns located to the right of the search area as the range of the interpolation extension area; or
if the quantity of taps of the interpolation filter is 12, using a pixel area with five columns located to the left of the search area and a pixel area with six columns located to the right of the search area as the range of the interpolation extension area; or
if the quantity of taps of the interpolation filter is 12, using a pixel area with five rows located above the search area and a pixel area with six rows located below the search area as the range of the interpolation extension area.

In some embodiments of this disclosure, based on the foregoing solutions, the determining unit 2006 is further configured to: adjust a coordinate position of the reference block, a coordinate position of the matching block, or the search area to be at an image boundary, if the coordinate position of the reference block, the coordinate position of the matching block, or the search area is outside the image boundary of the reference frame,
the image boundary of the reference frame being a boundary of a reference frame of image or a boundary obtained by extending the reference frame of image outward by an area with a specified size.

In some embodiments of this disclosure, based on the foregoing solutions, the specified area includes at least one of the following areas: a first pixel position in the search area, and a second pixel position in the reference block of the current block.

The determining unit 2006 is configured to determine, based on at least one of the following manners, the pixel value in the interpolation extension area configured for performing interpolation filtering processing:
copying the pixel value in the specified area as the pixel value in the interpolation extension area;
performing symmetry axis-based first symmetric processing on the pixel value in the specified area to obtain the pixel value in the interpolation extension area;
performing symmetry point-based second symmetric processing on the pixel value in the specified area to obtain the pixel value in the interpolation extension area;
performing weighting calculation on the pixel value in the specified area to obtain the pixel value in the interpolation extension area; and
obtaining the pixel value in the interpolation extension area based on the pixel value in the specified area through intra-frame prediction.

In some embodiments of this disclosure, based on the foregoing solutions, the determining unit 2006 is further configured to: determine at least one of the following information based on a default manner negotiated with an encoder side: the range of the search area, the range of the interpolation extension area, and the pixel value in the interpolation extension area; or
decode the video bitstream to obtain at least one flag bit, and determine at least one of the following information based on a value of the at least one flag bit: the range of the search area, the range of the interpolation extension area, and the pixel value in the interpolation extension area.

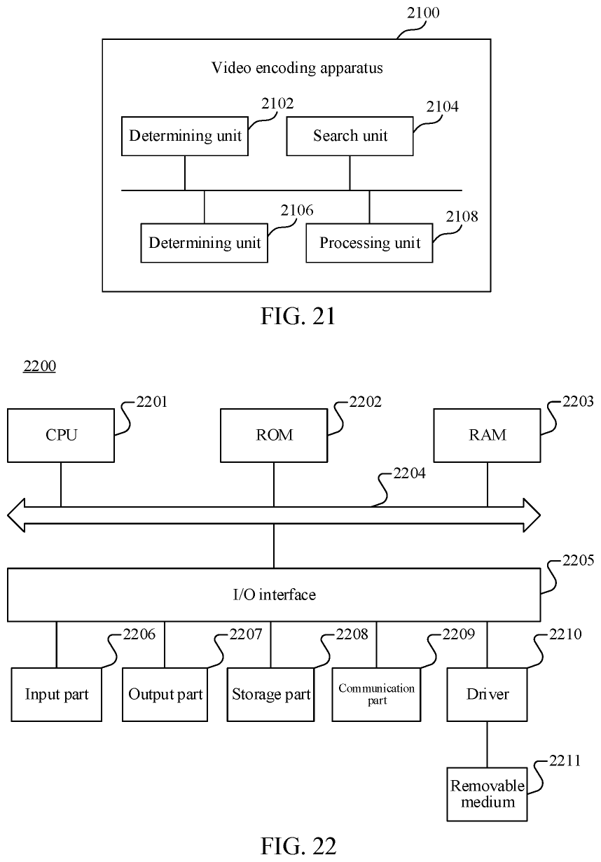

FIG. 21 is a block diagram of a video encoding apparatus according to an embodiment of this disclosure. The video encoding apparatus may be disposed in a device having a computing processing function, for example, may be disposed in a terminal device or a server.

Referring to FIG. 21, the video encoding apparatus 2100 according to this embodiment of this disclosure includes a determining unit 2102, a search unit 2104, a determining unit 2106, and a processing unit 2108.

The determining unit 2102 is configured to determine a candidate motion vector of a current block in an inter-frame template matching mode. The search unit 2104 is configured to search a search area in a reference frame based on the candidate motion vector to obtain a matching block of the current block. The determining unit 2106 is configured to determine, based on a pixel value in a specified area in the reference frame, a pixel value in an interpolation extension area configured for performing interpolation filtering processing. The processing unit 2108 is configured to perform interpolation filtering processing on the matching block based on the interpolation extension area.

FIG. 22 is a schematic structural diagram of a computer system suitable for implementing an electronic device according to an embodiment of this disclosure. The electronic device may be the video encoding apparatus or the video decoding apparatus in the foregoing embodiments.

The computer system 2200 of the electronic device shown in FIG. 22 is an example, and does not constitute any limitation on the function and scope of use of the embodiments of this disclosure.

As shown in FIG. 22, the computer system 2200 may include a central processing unit (CPU) 2201, which may perform various suitable actions and processes based on a program stored in a read-only memory (ROM) 2202 or a program loaded from a storage part 2208 into a random access memory (RAM) 2203, for example, perform the method in the foregoing embodiments. The RAM 2203 further has various programs and data required for system operation stored therein. The CPU 2201, the ROM 2202, and the RAM 2203 are connected to each other through a bus 2204. An input/output (I/O) interface 2205 is also connected to the bus 2204.

The following components may be connected to the I/O interface 2205: an input part 2206 including a keyboard, a mouse, and the like; an output part 2207 including a cathode ray tube (CRT), a liquid crystal display (LCD), a speaker, and the like; a storage part 2208 including a hard disk and the like; and a communication part 2209 including a network interface card such as a local area network (LAN) card or a modem. The communication part 2209 performs communication processing via a network such as an internet. A driver 2210 is also connected to the I/O interface 2205 as required. A removable medium 2211 such as a magnetic disk, an optical disk, a magneto-optical disk, or a semiconductor memory is installed on the driver 2210 as required, so that a computer program read from the removable medium is installed into the storage part 2208 as required.

For example, according to the embodiments of this disclosure, the process described in the foregoing reference flowchart may be implemented as a computer software program. For example, an embodiment of this disclosure includes a computer program product, including a computer program carried on a computer-readable medium, and the computer program is configured to perform the method shown in the flowchart. In such an embodiment, the computer program may be downloaded and installed from a network through the communication part 2209, and/or installed from the removable medium 2211. When the computer program is executed by the central processing unit (CPU) 2201, various functions defined in the system in this disclosure are performed.

An embodiment of this disclosure further provides a method for storing or transmitting a video bitstream, the video bitstream being decoded according to the foregoing video decoding method or being generated according to the foregoing video encoding method.

The computer-readable medium shown in the embodiments of this disclosure may be a computer-readable signal medium, a computer-readable storage medium, or any combination thereof. The computer-readable storage medium may be, for example, but is not limited to, an electric, magnetic, optical, electromagnetic, infrared, or semi-conductive system, apparatus, or device, or any combination thereof. More specific examples of the computer-readable storage medium may include, but not limited to, an electrical connection having one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In this disclosure, the computer-readable storage medium may be any tangible medium including or storing a computer program. The computer program may be used by or in combination with an instruction execution system, apparatus, or device. In this disclosure, the computer-readable signal medium may include a data signal being in a baseband or propagated as a part of a carrier, which carries a computer-readable computer program. A data signal propagated in such a way may use a plurality of forms, including, but not limited to, an electromagnetic signal, an optical signal, or any suitable combination thereof. The computer-readable signal medium may alternatively be any computer-readable medium other than the computer-readable storage medium. The computer-readable medium may send, propagate, or transmit a program used by or in combination with the instruction execution system, apparatus, or device. The computer program included in the computer-readable medium may be transmitted by using any suitable medium, including but not limited to: a wireless medium, a wired medium, or any suitable combination thereof.

The flowcharts and block diagrams in the accompanying drawings illustrate possible system architectures, functions, and operations that may be implemented by a system, a method, and a computer program product according to various embodiments of this disclosure. Each block in the flowcharts or the block diagrams may represent a module, a program segment, or a part of code. The module, the program segment, or the part of the code includes one or more executable instructions for implementing a specified logical function. In some alternative implementations, functions annotated in the blocks may be executed in a different order from those annotated in the accompanying drawings. For example, two boxes shown in succession may actually be performed basically in parallel, and sometimes the two boxes may be performed in a reverse order. This depends on the functions involved. Each box in the block diagrams or the flowcharts and combinations of boxes in the block diagrams or the flowcharts may be implemented by a dedicated hardware-based system that performs specified functions or operations, or may be implemented by a combination of dedicated hardware and a computer program.

Related units described in the embodiments of this disclosure may be implemented in a software manner, or may be implemented in a hardware manner, or the described units may be disposed in a processor. Names of these units do not constitute a limitation on the units in a case.

In another aspect, this disclosure further provides a computer-readable medium. The computer-readable medium may be included in the electronic device described in the foregoing embodiments; or may exist independently and is not assembled into the electronic device. The computer-readable medium carries one or more computer programs, and when the one or more computer programs are executed by the electronic device, the electronic device is caused to implement the method described in the foregoing embodiments.

Although several modules or units of a device configured to perform actions are mentioned in the foregoing detailed descriptions, such division is not mandatory. In fact, according to the implementations of this disclosure, the features and functions of the two or more modules or units described above may be embodied in one module or unit. On the contrary, the features and functions of one module or unit described above may be further divided to be embodied by a plurality of modules or units.

Through the foregoing descriptions of the implementations, the example implementations described herein may be implemented by software, or may be implemented by combining software with necessary hardware. Therefore, the technical solutions in the implementations of this disclosure may be embodied in a form of a software product. The software product may be stored in a non-volatile storage medium (which may be a CD-ROM, a USB flash drive, a removable hard disk, or the like) or on the network, including several instructions for enabling an electronic device to perform the method according to the implementations of this disclosure.

For example, the electronic device may be a video decoding apparatus, and the video decoding apparatus may perform the video decoding method shown in FIG. 12. For another example, the electronic device may be a video encoding apparatus, and the video encoding apparatus may perform the video encoding method shown in FIG. 19.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of video decoding, comprising:
decoding a video bitstream comprising coded information of frames to obtain a candidate motion vector of a current block in a current frame, the current block being coded in an inter-frame template matching mode;
searching a search area in a reference frame based on the candidate motion vector to obtain location information of a matching block of the current block;
determining, based on one or more first pixel values in a specified area in the reference frame, one or more second pixel values in an interpolation extension area for the matching block; and
performing interpolation filtering processing based on the interpolation extension area to obtain pixel values of the matching block.

2. The method according to claim 1, wherein the searching comprises:
determining, in the reference frame, a reference block of the current block as a search start point in the search area based on the candidate motion vector;
searching, based on the search start point, the search area for a motion vector with a best matching template to a template of the current block; and
determining the matching block of the current block based on the motion vector.

3. The method according to claim 2, wherein the search area comprises at least one of:
a first quantity of rows above the reference block;
a second quantity of rows below the reference block;
a third quantity of columns left of the reference block;
a fourth quantity of columns right of the reference block;
one or more pixels at an upper left of the reference block;
one or more pixels at an upper right of the reference block;
one or more pixels at a lower left of the reference block; and/or
one or more pixels at a lower right of the reference block.

4. The method according to claim 2, further comprising:
determining a range of the interpolation extension area based on at least one of: a position of the matching block, a quantity of taps of an interpolation filter for the interpolation filtering processing, and/or a range of the search area.

5. The method according to claim 4, wherein the determining the range of the interpolation extension area comprises:
when the interpolation filtering processing includes one or more pixels outside the range of the search area, obtaining the interpolation extension area that extends from the search area.

6. The method according to claim 5, wherein:
the obtaining the interpolation extension area comprises at least one of:
defining the interpolation extension area with a fifth quantity of rows above the search area and a sixth quantity of rows below the search area, when a first absolute difference between horizontal coordinates of upper-left corners of the reference block and the matching block of the current block is less than or equal to a first threshold, and a second absolute difference between vertical coordinates of the upper-left corners of the reference block and the matching block is greater than a second threshold;
defining the interpolation extension area with the fifth quantity of rows above the search area, when the first absolute difference is less than or equal to the first threshold, the second absolute difference is greater than the second threshold, and a difference between the vertical coordinates of the upper-left corners of the reference block and the matching block is greater than 0; and/or
defining the interpolation extension area with the sixth quantity of rows located below the search area, when the first absolute difference is less than or equal to the first threshold, the second absolute difference is greater than the second threshold, and a difference between the vertical coordinates of the upper-left corners of the reference block and the matching block is less than or equal to 0,
the first threshold is a difference between a half of a first quantity of taps of the interpolation filter in a horizontal direction and a first specified constant, and
the second threshold is a difference between a half of a second quantity of taps of the interpolation filter in a vertical direction and a second specified constant.

7. The method according to claim 5, wherein:
the obtaining the interpolation extension area comprises at least one of:
defining the interpolation extension area with a seventh quantity of columns left of the search area and an eighth quantity of columns right of the search area, when a second absolute difference between vertical coordinates of upper-left corners of the reference block and the matching block of the current block is less than or equal to a third threshold, and a first absolute difference between horizontal coordinates of the upper-left corners of the reference block and the matching block is greater than a fourth threshold;
defining the interpolation extension area with the seventh quantity of columns left of the search area, when the second absolute difference is less than or equal to the third threshold, the first absolute difference is greater than the fourth threshold, and a difference between the horizontal coordinates of the upper-left corners of the reference block and the matching block is greater than 0; and/or
defining the interpolation extension area with the eighth quantity of columns right of the search area, when the second absolute difference is less than or equal to the third threshold, the first absolute difference is greater than the fourth threshold, and the difference between the horizontal coordinates of the upper-left corners of the reference block and the matching block is less than or equal to 0,
the third threshold is a difference between a half of a first quantity of taps of the interpolation filter in a horizontal direction and a third specified constant, and
the fourth threshold is a difference between a half of a second quantity of taps of the interpolation filter in a vertical direction and a fourth specified constant.

8. The method according to claim 5, wherein:
the obtaining the interpolation extension area comprises at least one of:
defining the interpolation extension area with a fifth quantity of rows above the search area, a sixth quantity of rows below the search area, a seventh quantity of columns left of the search area, and an eighth quantity of columns right of the search area, when a first absolute difference between horizontal coordinates of upper-left corners of the reference block and the matching block of the current block is greater than a fifth threshold, and a second absolute difference between vertical coordinates of the upper-left corners of the reference block and the matching block is greater than a sixth threshold;
defining the interpolation extension area with the fifth quantity of rows above the search area, when the first absolute difference is greater than the fifth threshold, the second absolute difference is greater than a sixth threshold, and a difference between the vertical coordinates of the upper-left corners of the reference block and the matching block is greater than 0;
defining the interpolation extension area with the sixth quantity of rows below the search area, when the first absolute difference is greater than the fifth threshold, the second absolute difference is greater than the sixth threshold, and the difference between the vertical coordinates of the upper-left corners of the reference block and the matching block is less than or equal to 0;
defining the interpolation extension area with a seventh quantity of columns left of the search area, when the first absolute difference is greater than the fifth threshold, the second absolute difference is greater than the sixth threshold, and the difference between the horizontal coordinates of the upper-left corners of the reference block and the matching block is greater than 0; and/or
defining the interpolation extension area with an eighth quantity of columns right of the search area, when the first absolute difference is greater than the fifth threshold, the second absolute difference is greater than a sixth threshold, and the difference between the horizontal coordinates of the upper-left corners of the reference block and the matching block is less than or equal to 0,
the fifth threshold is a difference between a half of a first quantity of taps of the interpolation filter in a horizontal direction and a fifth specified constant, and
the sixth threshold is a difference between a half of a second quantity of taps of the interpolation filter in a vertical direction and a sixth specified constant.

9. The method according to claim 4, wherein the determining the range of the interpolation extension area comprises:
determining the range of the interpolation extension area according to at least one of:
a ninth quantity of rows above the search area;
a tenth quantity of rows below the search area;
an eleventh quantity of columns left of the search area;
a twelfth quantity of columns right of the search area;
one or more pixels at an upper left of the search area;
one or more pixels at an upper right of the search area;
one or more pixels at a lower left of the search area; and/or
one or more pixels at a lower right of the search area.

10. The method according to claim 4, wherein the determining the range of the interpolation extension area comprises at least one of:
when a quantity of taps of the interpolation filter is 4, defining the interpolation extension area with one row above the search area, two rows below the search area, one column left of the search area, and two columns right of the search area;
when the quantity of taps of the interpolation filter is 6, defining the interpolation extension area with two rows above the search area, three rows below the search area, two columns left of the search area, and three columns right of the search area;
when the quantity of taps of the interpolation filter is 8, defining the interpolation extension area with three rows above the search area, four rows below the search area, three columns left of the search area, and four columns right of the search area;
when the quantity of taps of the interpolation filter is 12, defining the interpolation extension area with five rows above the search area, six rows below the search area, five columns left of the search area, and six columns right of the search area;
when the quantity of taps of the interpolation filter is 12, defining the interpolation extension area with five columns left of the search area and six col right of the search area; and/or
when the quantity of taps of the interpolation filter is 12, defining the interpolation extension area with five rows above the search area and six rows below the search area.

11. The method according to claim 2, wherein:
the method further comprises at least one of:
when a coordinate position of the reference block is outside an image boundary of the reference frame, adjusting the coordinate position of the reference block to be at the image boundary;
when a coordinate position of the matching block is outside the image boundary of the reference frame, adjusting the coordinate position of the matching block to be at the image boundary; and/or
when a coordinate position of the search area is outside the image boundary of the reference frame, adjusting the coordinate position of the search area to be at the image boundary, and
the image boundary of the reference frame is a boundary of a reference frame or an outward extended boundary of the reference frame that extends outward from the boundary of the reference frame by a specified size.

12. The method according to claim 2, wherein:
the specified area comprises at least one of: a first pixel position in the search area, and/or a second pixel position in the reference block of the current block; and
the determining the one or more second pixel values comprises:
copying the one or more first pixel values in the specified area as the one or more second pixel values in the interpolation extension area;
performing symmetry axis-based first symmetric processing on the one or more first pixel values in the specified area to obtain the one or more second pixel values in the interpolation extension area;
performing symmetry point-based second symmetric processing on the one or more first pixel values in the specified area to obtain the one or more second pixel values in the interpolation extension area;
performing weighting calculation on the one or more first pixel values in the specified area to obtain the one or more second pixel values in the interpolation extension area; and/or
obtaining the one or more second pixel values in the interpolation extension area based on the one or more first pixel values in the specified area through intra-frame prediction.

13. The method according to claim 1, further comprising:
determining at least one of a range of the search area, a range of the interpolation extension area, and the one or more second pixel values in the interpolation extension area based on a default manner that is negotiated with an encoder side; or
determining at least one of the range of the search area, the range of the interpolation extension area, and the one or more second pixel values in the interpolation extension area based on at least a flag bit that is decoded from the coded information in the video bitstream.

14. A method of video encoding, comprising:
determining a candidate motion vector of a current block to be encoded in an inter-frame template matching mode;
searching a search area in a reference frame based on the candidate motion vector to obtain location information of a matching block of the current block;
determining, based on one or more first pixel values in a specified area in the reference frame, one or more second pixel values in an interpolation extension area for the matching block;
performing interpolation filtering processing based on the interpolation extension area to obtain pixel values of the matching block; and
encoding the current block into coded information in a video bitstream based on the pixel values of the matching block.

15. The method according to claim 14, wherein the searching comprises:
determining, in the reference frame, a reference block of the current block as a search start point in the search area based on the candidate motion vector;
searching, based on the search start point, the search area for a motion vector with a best matching template to a template of the current block; and
determining the matching block of the current block based on the motion vector.

16. The method according to claim 15, wherein the search area comprises at least one of:
a first quantity of rows above the reference block;
a second quantity of rows below the reference block;
a third quantity of columns left of the reference block;
a fourth quantity of columns right of the reference block;
one or more pixels at an upper left of the reference block;
one or more pixels at an upper right of the reference block;
one or more pixels at a lower left of the reference block; and/or
one or more pixels at a lower right of the reference block.

17. The method according to claim 15, further comprising:
determining a range of the interpolation extension area based on at least one of: a position of the matching block, a quantity of taps of an interpolation filter for the interpolation filtering processing, and/or a range of the search area.

18. The method according to claim 17, wherein the determining the range of the interpolation extension area comprises:
when the interpolation filtering processing includes one or more pixels outside the range of the search area, obtaining the interpolation extension area that extends from the search area.

19. The method according to claim 18, wherein:
the obtaining the interpolation extension area comprises at least one of:
defining the interpolation extension area with a fifth quantity of rows above the search area and a sixth quantity of rows below the search area, when a first absolute difference between horizontal coordinates of upper-left corners of the reference block and the matching block of the current block is less than or equal to a first threshold, and a second absolute difference between vertical coordinates of the upper-left corners of the reference block and the matching block is greater than a second threshold;
defining the interpolation extension area with the fifth quantity of rows above the search area, when the first absolute difference is less than or equal to the first threshold, the second absolute difference is greater than the second threshold, and a difference between the vertical coordinates of the upper-left corners of the reference block and the matching block is greater than 0; and/or
defining the interpolation extension area with the sixth quantity of rows located below the search area, when the first absolute difference is less than or equal to the first threshold, the second absolute difference is greater than the second threshold, and a difference between the vertical coordinates of the upper-left corners of the reference block and the matching block is less than or equal to 0,
the first threshold is a difference between a half of a first quantity of taps of the interpolation filter in a horizontal direction and a first specified constant, and
the second threshold is a difference between a half of a second quantity of taps of the interpolation filter in a vertical direction and a second specified constant.

20. A non-transitory computer-readable storage medium storing instructions which when executed by a processor cause the processor to perform a method of encoding a bitstream, the method comprising:
determining a candidate motion vector of a current block to be encoded in an inter-frame template matching mode;
searching a search area in a reference frame based on the candidate motion vector to obtain location information of a matching block of the current block;
determining, based on one or more first pixel values in a specified area in the reference frame, one or more second pixel values in an interpolation extension area for the matching block;
performing interpolation filtering processing based on the interpolation extension area to obtain pixel values of the matching block;
encoding the current block into coded information in the bitstream based on the pixel values of the matching block; and
transmitting the bitstream.
